(19) United States
(12) Patent Application Publication
(10) Pub. No.: US 2012/0185355 A1
(43) Pub. Date: Jul. 19, 2012

(54) SOCIAL SHOPPING APPARATUS, SYSTEM AND METHOD

(75) Inventor: Karen S. Kilroy, Akron, OH (US)

(73) Assignee: SUAREZ CORPORATION INDUSTRIES, North Canton, OH (US)

(21) Appl. No.: 13/350,231

(22) Filed: Jan. 13, 2012

Related U.S. Application Data
(60) Provisional application No. 61/585,464, filed on Jan. 11, 2012.
(60) Provisional application No. 61/449,269, filed on Mar. 4, 2011.
(60) Provisional application No. 61/432,714, filed on Jan. 14, 2011.

(51) Int. Cl. G06Q 30/00

(52) U.S. Cl. 705/26.8

(57) ABSTRACT

A method and system for online shopping, and more specifically, a method and system for providing a shared shopping experience where users on remote computers can shop online together in a social environment as a group with the ability to split the costs of the items bought as a group.

### CROSS-REFERENCES TO RELATED APPLICATIONS

This application claims the benefit of provisional application Ser. No. 61/585,464 filed on Jan. 11, 2012, incorporated herein by reference, provisional application Ser. No. 61/449,269, filed on Mar. 4, 2011, incorporated herein by reference, and provisional application Ser. No. 61/432,714, filed on Jan. 14, 2011, also incorporated herein by reference.

### BACKGROUND OF THE INVENTION

This application relates generally to a method and system for online shopping, and more specifically, this application relates to a method and system for a shared shopping experience where users on remote computers can shop online together in a social environment.

Conventional approaches for shopping tend to be a unitary experience where individuals browse a web site representing a store, for example, and purchase products in a solo manner. However, in the “real world”, shopping is often a social activity where friends and/or family socialize while shopping together at real stores.

As the Internet evolves, its use becomes more social, as shown by the success of such sites as Facebook and Twitter. As people seek out other people online, their interest in “doing something together” is expanding rapidly. Outside of gaming and a handful of business applications, there are very few collaborative applications available.

As mentioned above, online shopping is generally something that is currently done alone. Conversely, as also mentioned above, “real world” shopping is something that is frequently a social occasion. Shared shopping would make online shopping more like the real thing, in the sense that shoppers can shop together with friends and family.

A big problem for online retailers, especially in online mall situations, is that the Internet doesn't allow for much distinction on anything except price. So instead of providing the most pleasant shopping environment, the best customer service, etc., the merchants must compete primarily on price. Frequently, a merchant's wares are shown as a catalog entry in a megastore with no personality of their own store whatsoever. These shortcomings reduce profits and make the shopping experience less enjoyable.

Useful would be the ability for individuals (e.g., friends and family) to shop in a coordinated and more social manner in online shopping forums, despite the individuals being on separate computers remotely located from each other. This would then make the online shopping experience a social event more like conventional shopping experiences. Also useful would be vendor participation in this shopping experience to provide customer service improvements and the ability to project the store personality to the user. This would allow for competitive approaches to online shopping other than primarily relying on price competition.

### SUMMARY OF THE INVENTION

Provided are a plurality of embodiments a social shopping system adapted for providing a social aspect to online shopping.

Also provided is a method of providing a social shopping experience, comprising one or more of the steps of:
providing an online store;
providing an inviting shopper with means of inviting one or more other shoppers to shop at the online store together as a group, wherein each of the shoppers is participating in shopping at the online store using a user computer remote from each other;
providing a cart scenario by allowing each one of the shoppers in the group to control which of the other shoppers in the group may add items to the one of the shoppers shopping cart and which shoppers may see which items are in their own shopping carts, wherein the inviting shopper or another shopper designated by the inviting shopper has advanced privileges in setting the cart scenario;
allowing each of the shoppers to add items to others of the shoppers shopping carts according to the cart scenario;
providing a chat function so that the shoppers in the group can chat with each other; and
providing a means for each shopper to pay for the items in his or her own shopping cart.

Also provided is method of providing an online shared shopping session, comprising the steps of:
providing an online store for access to an initial shopper using a communication device;
providing the initial shopper with a communication interface for inviting one or more additional shoppers to shop at the online store together as a group of shoppers;
sending a message to the additional shoppers invited by the initial shopper over a communication network, such that each one of the additional shoppers can join the group of shoppers by responding to the message, wherein the additional shoppers each participate in shopping at the online store using a communication device distinct from others of the shoppers;
providing each one of the shoppers of the group of shoppers with a link to a shared shopping cart for adding one or more items to the shared shopping cart, such that contents of the shared shopping cart can be viewed by all of the shoppers; and
providing each one of the shoppers with a payment interface, such that more than one of the shoppers contributes payment toward purchase of the items added to the shared shopping cart.

Further provided is a method of providing an online shared shopping session, comprising the steps of:
registering a plurality of individual shoppers to a shopping group, wherein at least two of the shoppers access the shared shopping session using different communication devices;
providing each one of the shoppers with access to a shared shopping cart for indicating items for purchase by the shopping group, wherein each one of the shoppers can add items for purchase to the shared shopping cart using one of the communications devices;
for each one of the shoppers, accepting an individual payment percentage amount indicating a percentage of the total cost of the items to be paid by a corresponding one of the shoppers; and
providing a checkout function to be activated by one or more of the shoppers, wherein when the checkout function is completed, each one of the shoppers has contributed payment toward purchase of the items according to the individual percentage amount corresponding to that one of the shoppers.

Further provided is a method of providing an online shared shopping session, comprising the steps of:
registering a plurality of individual shoppers to a shopping group, wherein at least two of the shoppers are accessing the shared shopping session using different communication devices;
providing each one of the shoppers with access to a shared shopping cart for indicating items for purchase by the shopping group, wherein each one of the shoppers can add items for purchase to the shared shopping cart;
for each one of the shoppers, accepting an individual payment percentage amount indicating a percentage of the total cost of the items to be paid by a corresponding one of the shoppers;
validating that the sum of the individual payment percentage amounts of all of the shoppers totals one-hundred percent;
providing a checkout function to be accessed by each one of the shoppers, wherein for all of the shoppers: each one of the shoppers executes an individual checkout process for receiving payment information from that one of the shoppers, such that subsequent to the individual checkout process, that one of the shoppers has completed the checkout process and has contributed payment toward purchase of the items according to the individual percentage amount corresponding to that one of the shoppers, wherein
when any one of the shoppers first accesses the checkout function, the shared shopping cart is locked such that no more items can be added to the shared shopping cart by any of the shoppers; and
when the individual checkout function is completed for all of the shoppers, the sale of the items to the group is completed.

Further provided a method of providing an online shared shopping session, comprising the steps of:
providing an online shopping mall including a first shopping site and a second shopping site;
registering a plurality of individual shoppers to a shopping group, wherein at least two of the shoppers are accessing the shared shopping session using different communication devices;
providing each one of the shoppers with access to a shared shopping cart for indicating items for purchase by the shopping group from either of the first shopping site and the second shopping site, wherein each one of the shoppers can add items for purchase to the shared shopping cart;
for each one of the shoppers, accepting an individual payment percentage amount indicating a percentage of the total cost of the items to be paid by a corresponding one of the shoppers;
validating that the sum of the individual payment percentage amounts of all of the shoppers totals one-hundred percent;
providing a checkout function to be accessed by each one of the shoppers, wherein for all of the shoppers: each one of the shoppers executes an individual checkout process for receiving payment information from that one of the shoppers, such that subsequent to the individual checkout process, that one of the shoppers has completed the checkout process and has contributed payment toward purchase of the items according to the individual percentage amount corresponding to that one of the shoppers, wherein
when any one of the shoppers first accesses the checkout function, the shared shopping cart is locked such that no more items can be added to the shared shopping cart by any of the shoppers;
when the individual checkout function is completed for all of the shoppers, the sale of the items to the group is completed; and
providing payment to the first shopping site and the second shopping site based on items purchased by the group provided by the respective site.

Also provided is a method of providing an online shared shopping session, comprising the steps of:
providing an online store for access to an initial shopper using a communication device;
providing the initial shopper with a communication interface for inviting one or more additional shoppers to shop at the online store together as a group of shoppers;
sending a message to the additional shoppers invited by the initial shopper over a communication network, such that each one of the additional shoppers can join the group of shoppers by responding to the message, wherein the additional shoppers each participate in shopping at the online store using a communication device distinct from others of the shoppers;
providing each one of the shoppers with access to a shared shopping cart for indicating items for purchase by the shopping group, wherein each one of the shoppers can add items for purchase to the shared shopping cart, wherein the contents of the shared shopping cart can be viewed by all of the shoppers;
providing each one of the shoppers with a personal shopping cart for purchasing items outside of the group;
providing a chat function so that the shoppers in the group can chat with each other while shopping;
for each one of the shoppers, accepting an individual payment percentage amount indicating a percentage of the total cost of the items to be paid by a corresponding one of the shoppers;
validating that the sum of the individual payment percentage amounts of all of the shoppers totals one-hundred percent;
providing a checkout function to be accessed by each one of the shoppers, wherein for all of the shoppers: each one of the shoppers executes an individual checkout process for receiving payment information from that one of the shoppers, such that subsequent to the individual checkout process, that one of the shoppers has completed the checkout process and has contributed payment toward purchase of the items according to the individual percentage amount corresponding to that one of the shoppers, wherein
when any one of the shoppers first accesses the checkout function, the shared shopping cart is locked such that no more items can be added to the shared shopping cart by any of the shoppers; and
when the individual checkout function is completed for all of the shoppers, the sale of the items to the group is completed.

Further provided is a method of providing an online shared session, comprising the steps of:
providing an initial user with a communication interface for inviting one or more additional users to access the session as a group of users;
sending a message to the additional users invited by the initial user over a communication network, such that each one of the additional user can join the group by responding to the message, wherein the additional user each participate in the shared session using a communication device distinct from others of the users;
displaying one or more common pages among all of the users during the online shared session, wherein the sharing includes sending URL information of a page viewed by one of the users to the others of the users for use in displaying the page on their respective communication devices; and
providing a chat function so that the users in the group can chat with each other during the shared session.

Further provided is a method of providing an online shared shopping session, comprising the steps of:
providing a central server owned by a first vendor to support the online shared shopping session;
providing a remote server for supporting a merchant shopping site originally independent of the shared shopping session;
providing a software plug-in for installation and execution in the remote server to enable the merchant shopping site to support the shared shopping session, wherein providing the shared shopping session includes the steps of:
providing an online store for access to an initial shopper using a communication device,
providing the initial shopper with a communication interface for inviting one or more additional shoppers to shop at the online store together as a group of shoppers,
providing each one of the shoppers of the group of shoppers with a link to a shared shopping cart for adding one or more items to the shared shopping cart, such that contents of the shared shopping cart can be viewed by all of the shoppers, and
providing each one of the shoppers with a payment interface, such that more than one of the shoppers contributes payment toward purchase of the items added to the shared shopping cart; and
providing payment from the merchant to the vendor for supporting the shared shopping session.

Also provided are any of the above methods further providing a chat function so that the shoppers in the group can chat with each other while shopping, and/or also providing each one of the shoppers with a personal shopping cart for purchasing items outside of the group.

Further provided is a system or a number of cooperating systems comprising one or more servers executing software on microprocessors for implementing any of the above methods.

Also provided are additional embodiments of the invention, some, but not all of which, are described hereinbelow in more detail.

### BRIEF DESCRIPTION OF THE DRAWINGS

The features and advantages of the examples described herein will become apparent to those skilled in the art to which this disclosure relates upon reading the following description, with reference to the accompanying drawings, in which:

FIG. 1 is a high-level diagram showing one example embodiment of a system for implementing an example shared shopping approach;

FIG. 1a is a high-level diagram showing another example embodiment of a system for implementing an example shared shopping approach;

FIG. 2 is a high-level diagram showing example computer hardware that could be used for implementing some of the example embodiments;

FIG. 2a is a high-level diagram showing example computer hardware that could be used in an example centralized system supporting shared shopping;

FIG. 2b is a high-level diagram showing another example of computer hardware that could be used for implementing others of the example embodiments;

FIG. 3 is a flow diagram showing example relationships between example participants and example hardware in an example shared shopping system;

FIG. 4 is a diagram listing example software functionality of an example shared shopping system for a shopping mall;

FIG. 5 is a high-level flow chart showing example shared shopping functionality of a shared shopping system using Magento tools;

FIG. 6 is a flow chart showing an example process flow for an example single store shared shopping system;

FIGS. 7A-7B are a flow chart showing example communications features of an example shared shopping system; and

FIGS. 8A-8H show portions of example shopper screen shots of an example shared shopping system.

### DETAILED DESCRIPTION OF THE EXAMPLE EMBODIMENTS

Shared shopping, (aka social shopping or group shopping), is an online shopping innovation and a social networking innovation. Shoppers can “meet”, via their remotely located computers or other network-connected devices, at an online store or shopping mall (collection of stores), form ad-hoc shopping groups, and shop together. Shoppers can build social groups based around collaborative online shopping activities of common interest. Salespeople, using their own computing devices connected to the network, can guide shoppers through a store in order to sell the items, answer questions, and provide other personal services, making the shopping experience more enjoyable and more rewarding.

With shared shopping, individuals can collaborate and socialize in a joint shopping event, and the merchant can provide a customer service person to “show” items to an online shopper, answer questions, and provide product information and alternative products. With a shared shopping mall, the merchant can be accessible through an interface that offers multiple stores, yet retain its own personality. This gives the merchant a chance to make the sale with superior customer service, rather than just based on price.

Practical applications for shared shopping are not limited to products, as application can also include services. For example, a broker that books activities for tourists could use shared shopping. A family of five logs into a website because they are traveling to someplace warm to escape the Cleveland winter. A website provides deals relating to things to do on vacation. Some items are al carte, and other items are group related. For example, swimming with the turtles for an hour is a pay by person per hour basis. However, renting 2 jet skis and splitting those costs among all the members of the family requires the split checkout function. Yet, each person is booking and paying their individual share, but some activities are booked for the group. This way there is no arguing over splitting the bill at the time of the activity.

Online shopping could also be used for service products like insurance, mortgages, financial planning and investments, etc. which are all services where shoppers tend to have a lot of questions and many options to evaluate.

Another application for shared shopping functionality would be a shared shopping hosted online shopping mall. This would entail an entity to host an online mall where a plurality of vendors can transact with customers using the shared shopping features. A mall in this case should be defined as, but is not limited to, two or more merchants in one area. This could be online (e.g., one online shopping site), or in an actual physical place (an actual shopping mall or plaza). Such a place would be defined as a place of business. Business would be selling goods or services in everyday normal operations.

This social shopping model can also be leased out to companies having multiple brands. For example, General Motors has multiple product lines. If a customer goes on to the General Motors website and the customer is only specifically shopping for General Motors products, this could be considered a shopping “mall”. A site providing access to many different manufactured automotive brands could also be provided, like the “auto miles” in some neighborhoods where many dealers are grouped together.

For at least some embodiments, shoppers will be able to determine whether they want to share a cart, or whether they want to have individual carts, or a combination of sharing and individual carts. Combination carts are useful for shoppers who what to shop for personal items while also shopping for group items. For some embodiments, the shoppers will determine who is leading the shared shopping trip, and whether or not their group is visible to others not in the group. The shopper who creates the trip may issue email invitations to others, and decide whether or not other shoppers may be invited by members of the proposed shopping group. In other embodiments, no one shopper has any more control or abilities than any other shopper. In still other embodiments, variations on these functions can be provided.

When shared shopping is extended to multiple connected stores, in particular stores having different, complementary types of merchandise, this constitutes a shared shopping mall. Shoppers can shop among all stores in a mall before checking out, comparing items among stores, and adding them to a single shared cart until they all have finished shopping. Shoppers can do this alone, as well as in a shared shopping group. When the shared shopping mall is extended to include a group communications tool, it becomes a hub for online social activity, by providing texting, chatting, voice, or even video communications tools to enhance the social aspect of the social shopping experience.

In one system, one shopper may have superior control over the shared shopping cart, such as the ability to determine when the items are finally purchased, the ability to determine who is allowed to add to or delete from the cart, who pays what portion of the costs, or other control functionality. Alternatively, in some embodiments all shoppers may have equal control over a cart, and thus avoid any special roles or responsibilities for one shopper. In such embodiments, any given shopper may be able to check out his or her portion of the cart by either purchasing the individual items he or she chose, or by paying is or her fair share of the cost, for example, leaving the others to choose when to pay their fair share. However, time limits are likely desirable to ensure that the chosen products are eventually purchased and delivered (typical delivery is by carrier delivery to an address, although pickup options may be available).

Parts of the shared shopping system could utilize resources currently being used by participating merchants. For example, servers that host data and store data relating to the customers of a merchant that are currently implemented by merchants could be utilized. Other features might include the ability for a customer to log into social networking systems and use chat features.

The system itself can be made flexible because it could be implemented all on one party's hardware, or it can be split up among merchant hardware and centralized (specialized) hardware. This allows for a range of services to vary from party to party, allowing customization, where desired.

Services can be hosted and performed by third parties, where desired. For example, the use of plug-ins can be a very effective solution. Plug-ins could allow shared shopping to be implemented on a website, yet only store specific data collected. This data could be stored and held by a third party. Therefore the system could be a “cloud-based” service, where multiple third parties perform services directly relating to the shared shopping process.

Other options include proprietary licensing for a custom solution where said system is set up specifically for a vendor merchant, in this case the hosting and computing could be done on the merchant end.

An important concept in one practical shared shopping approach is the concept of screen sharing, so that shoppers on computers physically remote from each other (and possibly remote from any retail establishment that they may want to patronize) can view common items for discussion and purchase.

Shared carts can be implemented by constructing a separate cart routine. This would mean duplication of the current cart and would be visible by all individuals in the shopping group. The final cost of this cart will split among the members of the shopping group in some manner. When an item is shared between members, the cost of this item can be added to a shopper's individual cart after everyone in that group has purchased the item(s). The product(s) remain in that temporary cart until payment is received from all customers, when the product(s) becomes a purchased item for delivery or pickup.

For example, the actual product can be placed in the personal cart of the group member that added it. The placeholder in each group member's cart will act as a price adjustment. The person who added the product will have a credit for the amount that the other members are committed to paying. The other members will have a charge for the amount they committed to pay.

Customers can typically pay by cash or credit. The bill can be split based on a combination of those two, cash or credit, on percentages, dollar value, net realizable value (if it's a replacement item). Tax implications and shipping calculations can be taken into account in shared shopping, as in existing solo shopping arrangements.

DEBIT/CREDIT Cards, PayPal or other payment systems, banks and financial institutions, gift cards/certificates, and promotional coupon codes all relate to the payment and can be supported by shared shopping. There should be a sequential order to go through to ensure that all payment methods are accepted and are processed in their correct and full amounts.

Revenue Models

There are multiple revenue models that Shared shopping can utilize to ensure that the provider of shared shopping is compensated for the functionality. However, these are not limited to those mentioned.

One model is to charge a percentage of sales and/or a transaction fee, as a commission. This model comprises tracking the number of shoppers that used shared shopping on a given client's website. What shared shopping brings to the table is as follows: a cart shared by a group, the ability to chat with a customer service representative, the ability to split the bill of the shared cart among members of the group and finally one or more means of communicating with other shoppers in the group (and possibly shoppers outside of the group).

As an example, it could work as follows: A shopper goes to the website, and automatically has the ability to chat with a customer service representative of one or more merchants represented by the website. The provider of the shared shopping system may reserve the right to limit the number of customer service representatives online at one time (e.g., to conserve resources). This is partially controlled by the cost of the servers, and their capacity. This service can be provided free to both parties (client merchants and shoppers), or a fee may be involved (in particular on the merchant). Once a shopper clicks on a group, or joins and initiates the first name, last name and nick name id boxes, a usage counter will increase by one. The usage counter keeps track of how many shoppers essentially signed into a given shared shopping session. The usage counter will be totaled, such as at the end of the month, and will be multiplied by a stated rate to give the client the total monthly usage billing period. Rates may be fixed, or based on some schedule.

A second part of this model can be a charge based on the percentage of sales. Once a shopper “signs in or signs up,” the shopper can join a group, or form a group to allow the shopper access to the shared cart feature. Once payment is initiated, and assurance of payment is confirmed, the total dollar amount of the shared cart is tracked by the unique group session and the shared shopping merchant (the client of the system) will be billed a percentage of the sale. This is in response to the merchant's customers using the split checkout feature that they would not ordinarily have access to. This feature increased shopping and sales for the retailer, and thus the Shared Shopping should be compensated accordingly by such a commission. This could be done at the API Level of the cart, such that that one cart could accept multiple payments.

Another potential source of revenue could be a flat monthly fee. This could be based upon a tier model that is seen in traditional software. Another way of billing clients (merchants) would be a one-time fee. Finally, instead of tracking users of shared shopping, one could track the number of groups formed and take a significantly higher percentage of the shared cart sales. These are numerous ways that customers can be charged for the services and products they have used to compensate the system provider.

Still another revenue model would support a “referral” type of service, where a social, hobby, or business group may form at a site supporting such groups for a purpose other than shared shopping, but the group is referred to an e-commerce site using the shared shopping feature. Payment could be made depending on who is running the shopping site. If the site supporting the group also sells products or services, it might pay for the shared shopping feature, but if that site is referring the group to another shopping site, then the referring site may get paid for the referral, such as by fee or commission. In this manner, shopping sites that are focused on particular groups (based on hobbies, social organizations, or businesses, for example), can link up with sites that support such groups in other ways, to the benefit of both types of sites. And the users get the benefit of supporting their groups activities and getting related products and services all linked together. Advertising could also be used to generate revenue, such as by using banner ads on a shared shopping bar, or window panes. Click-through charges could also be utilized, if desired.

These revenues must compensate for the costs of providing the system, which include, but are not limited to, the cost of servers, software development, costs of billing, and costs associated with customer technical support, among others.

The focus of the shared shopping system is the ability to provide a shared shopping experience to shoppers. This experience is at least partially based on the shared cart and the split checkout. In essence, sharing items and paying portions is sharing the cost among shoppers. This may be particularly useful for big ticket items such as jewelry and electronics. For example, a group of 4 may want to split the costs of a $1000 3D TV. They may be getting it as a wedding present for a couple, for example. One thousand dollars split four ways is $250 a person, a much more reasonable sum for a wedding present for most people. That's one item in a shared cart with 4 split payments. This is basically a hassle free way to shop as a group, because everyone pays their share immediately. There is no worry about “are they going to pay me back?” if one person fronts the cost. Also, it can optionally be split unevenly by specifying a particular payment percentage for each shopper to pay, which may be chosen by the individual shopper, or by group consensus, for example. Or the system may calculate the individual payment percentage (such as by dividing the total cost by the number of shoppers for all to share equally, for example). Sticking with the same example scenario, let's say that one of those 4 persons has been out of work for some time. Maybe that person only pays $50 instead of the $250 and the others pick up the rest of the slack because they have good paying jobs. The key feature of splitting the bill is the negotiation process that can be supported by the shared shopping system.

The negotiation process is defined as, but not limited to, taking payment information from the shoppers (perhaps including the individual payment percentage to determine the percentage of the total cost to be contributed by each shopper), sending a request for a security token, and receiving authorization or denial of a request. This process can include one token or multiple tokens. This process can be on a Shared Shopping server, a payment gateway server, or a retailer's server. However, it is not limited to these solutions listed. The negotiation process can be a cloud based solution and licensed out, for example. The negotiation process can be a hosted solution for payment gateway services, and/or retailers to use for a fee.

These features can be implemented at the Shopping cart API level as well. The Shopping cart doesn't need to be actually “shared” if the API allows for multiple tokens. The cart can be hosted by a centralized shared shopping, a 3rd party, or a retailer. This would be a common API allowing the retailer and the payment accepter to link those multiple tokens.

For example, using the same previous example of buying the 3D TV: A group of four people are purchasing it as a gift. However, three of the people are working substantial hours and don't have any time to shop. They put their trust with the 4th member of the group to find the best TV for the best price. The 4th member logs on and finds the product that the group is looking for. The 4th member initiates the checkout process. To get the other members to pay their share of the item, the 4th member sends the URL of the payment screen to the other members of the group. Their billing information is taken and multiple tokens are given. If one person delays, the transaction isn't processed until all tokens are returned making the purchase approved. If the purchase isn't approved right away, it is therefore pending until the whole bill is covered, until it expires after a predetermined time, if desired.

This negotiation process can be moved around in the checkout process due to the risk of accepting certain payment methods. A debit transaction is likely to be less risky on a vendor than a credit transaction. With credit transactions, there is a limit to the individual credit card and there is an uncertainty in collectability. Revenue recognition is based off of the ability to collect the receivable. One party will typically pay for the risk. This is why this process can be negotiated in different areas of the checkout process and on different parties' assets.

Many of the features are supplemental to the shared cart and split checkout. For example, chatting with a customer service representative. This may be especially important for certain products such as jewelry. Using the following example for illustrative purposes: a man is buying a present for his girlfriend from Tiffany & Co. He asks his sister's opinion through a shared shopping session about some of the jewelry. Jewelry comes in many shapes and sizes, and many different costs and qualities. It's important that the specifications be correct in this purchase. After consulting with a customer service representative on what is available, the man and his sister make a purchase over the Internet. Traditionally, this purchase would have been made in a jewelry store, requiring additional time and travel.

Such examples need not to be limited to 3 people in a session. If Tiffany & Co. wanted to have a sale on a particular line of jewelry, for example Elsa Perreti necklaces, they could host a jewelry party with shared shopping. Each necklace in the showcase could be represented by one customer service representative to the shoppers. In essence, the shoppers have formed a group even though they are part of the Tiffany Community, although this group is not likely to share a cart. These are services that can be supported by the shared shopping model. However, taking this example one step further, an interested purchaser signs into the shared shopping model because he or she invites 2 of his or her friends to the site. Then Tiffany is charged for a usage fee once they have signed in. Shoppers who bring other shoppers to the group may earn a commission or discount, for example.

Example Methods of Screen Sharing

Screen sharing is a useful method of providing shared shopping functionality. Screen sharing among group members can, for example, be achieved by passing URLs through silent messages between browsers. In essence, if screen sharing is active, the driver browser (the “driver” is typically the shared shopping session initiator) sends a new URL to all of the passenger browsers (the “passengers” are the additional members of the shared shopping grout that are not the driver) so that all members of the group can see the page or graphic item represented by the URL. This is processed sequentially, because a driver's browser “checks” to see if the URL is a page (or other item to be shared) before passing to passengers.

The concept of drawing on a canvas which is used in “remote me” can also be used—these features use the Java canvas solution. For this method, Java enables a passenger computer to draw exactly what the driver sees on the driver's screen. It keeps track of mouse methods and keyboard actions.

Use of Screen shots—Pictures of screens can be taken and passed, through chat, browsers, and email functions. This may create problems in terms of real time processing, but there can be methods written where browsers take screen shots and send those to others. For example, shots could be taken and send out every 45 seconds, while the shared shopping process is going on.

There are also many scripting languages that can keep track of the shopping session using the browser and which do not need other software.

One preferred version of screen sharing is to use the screen following technique. As mentioned above, this passes URLs back and forth between the browsers to share views. However, each person has control over who is followed. Individuals may also choose not to follow someone, if desired. This choice is toggled by checking the box in a group window pane. This is more realistic and closer to an actual “going to the store” experience. When two people go to the store, they could be looking in the same aisle of products but not actually looking at the exact same products, for example.

For example, a man and wife walk into a jewelry store. The woman is looking at engagement rings and the man is looking at watches. If the man is interested in what the woman is looking at, he may ask her what she is doing, or he may go over to the product she is looking at and check it out himself. On the web in shared shopping, the same can be achieved by the use of screen following: The man could be looking at watches and the woman could be looking at engagement rings. The women chats, “look at what I found” to the man. He selects her in their formed group and her URL is passed to his browser, and he is then looking at the same product that she is looking at (and thereby possibly knowing what she is referring to).

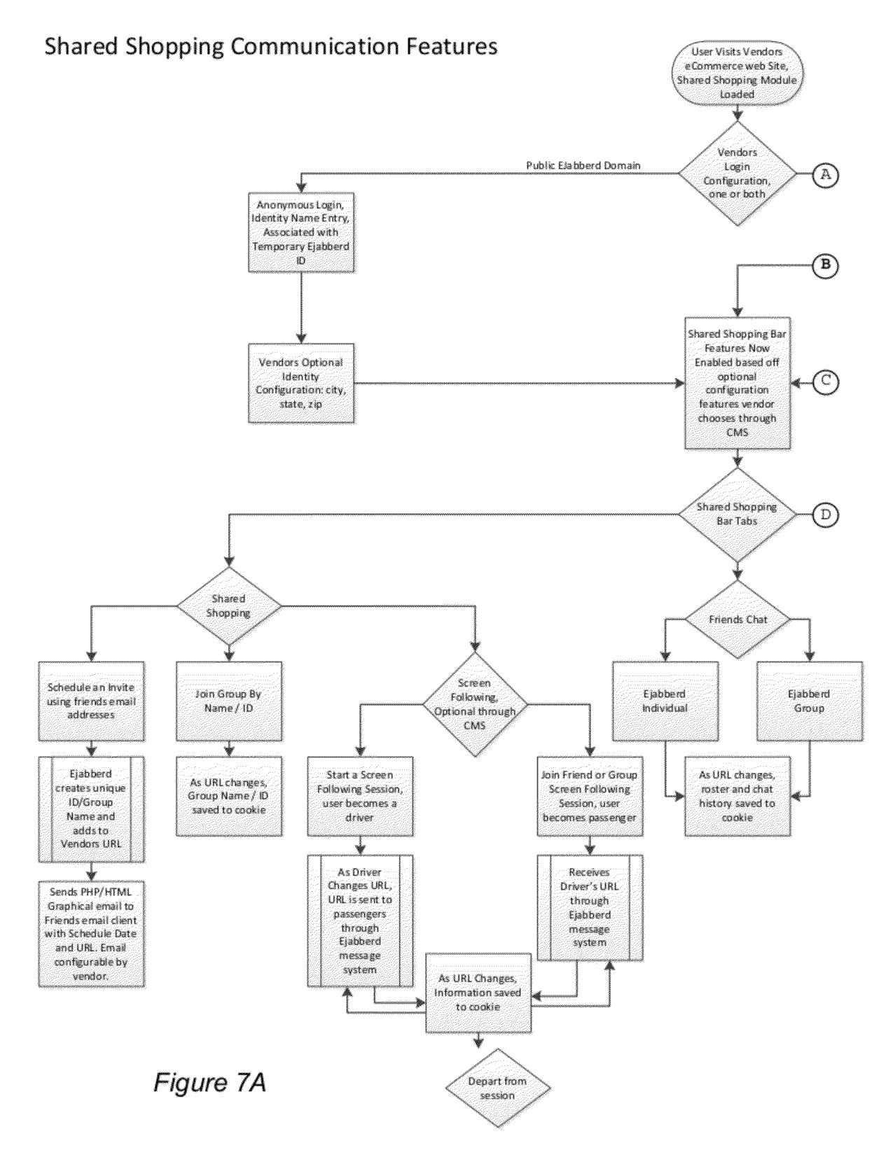

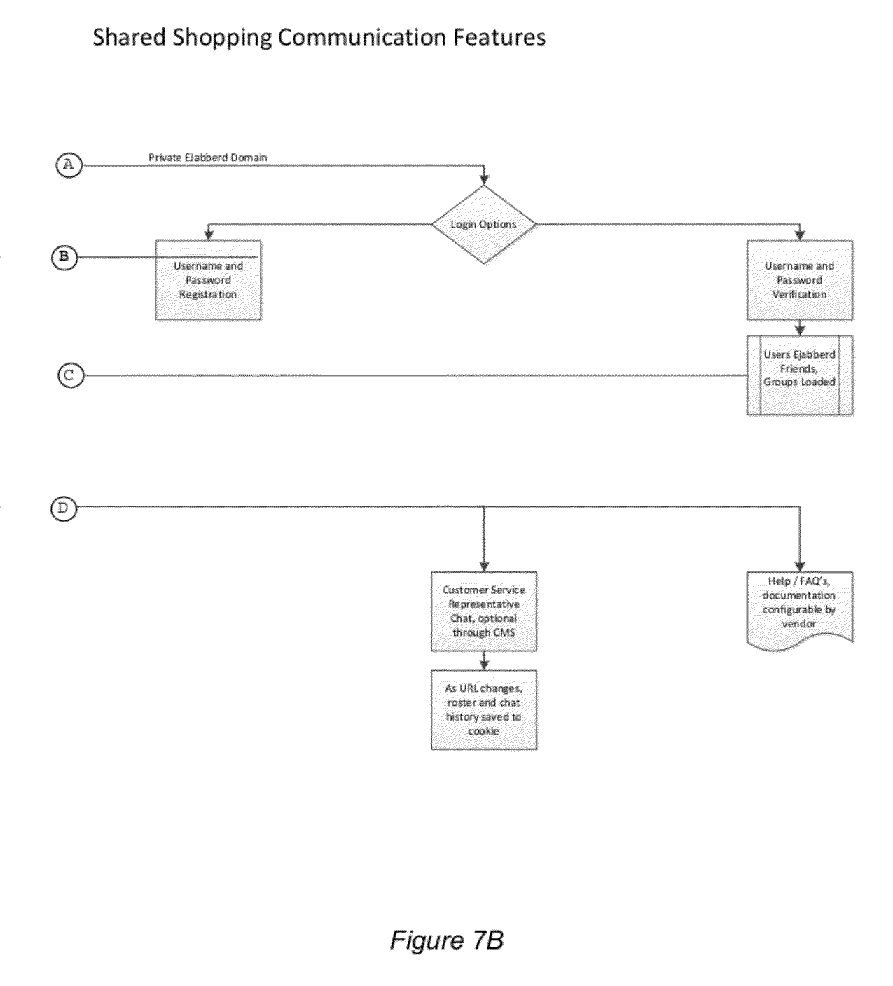

As discussed above, providing chat functionality and customer service can also be a part of the shared shopping experience. This could be provided using voice, such as by providing the ability to record and send a voice message over the Internet, using VOIP or ejabberd (an instant messaging solution). Currently, ejabberd is being used in a shared shopping Magento version, and thus may be a preferred method of providing this functionality. FIGS. 7A-7B show a shared shopping communications features flow chart utilizing ejabberd to implement the features discussed in this application.

Magento is a feature-rich eCommerce platform built on open-source technology that provides online merchants with unprecedented flexibility and control over the look, content and functionality of their eCommerce store.

Magento's intuitive administration interface features powerful marketing, search engine optimization and catalog-management tools to give merchants the power to create sites that are tailored to their unique business needs. Designed to be completely scalable and backed by a support network, Magento offers companies the ultimate eCommerce solution Thus, Magneto platforms could be utilized for providing the features of shared shopping allowing for wide compatibility.

Instant Messages, similar to the original AOL instant messaging, ICQ, or Facebook chat, for example, can also be utilized. Members can also communicate outside of the functions provided for them by telephone, for example. VOIP does include a phone-like feature. This can be especially useful for customers who are blind, or are visually impaired.

Customers can also interact through email. For example a customer service representative agrees to get back to a member in the group about a new product. The customer service representative may not be able to answer questions posed by the group at the time the question is asked. Email is one way that a representative can get back to a member of the group at a later time.

Social media such as Facebook, which uses similar protocols as mentioned above, could also be used for such communication.

System Architecture

For some embodiments, shared shopping can be implemented using a client-server or peer-to-peer technique which allows one client browser to invoke a URL to appear on multiple browsers simultaneously, which belong to the browsing (shopping) group. The URL is stored in a shared shopping session which is written either to a web server, or to the files of a shopping group member's computer. This URL is typically stored temporarily, but could be stored longer term depending on the specific application of the shared shopping technology.

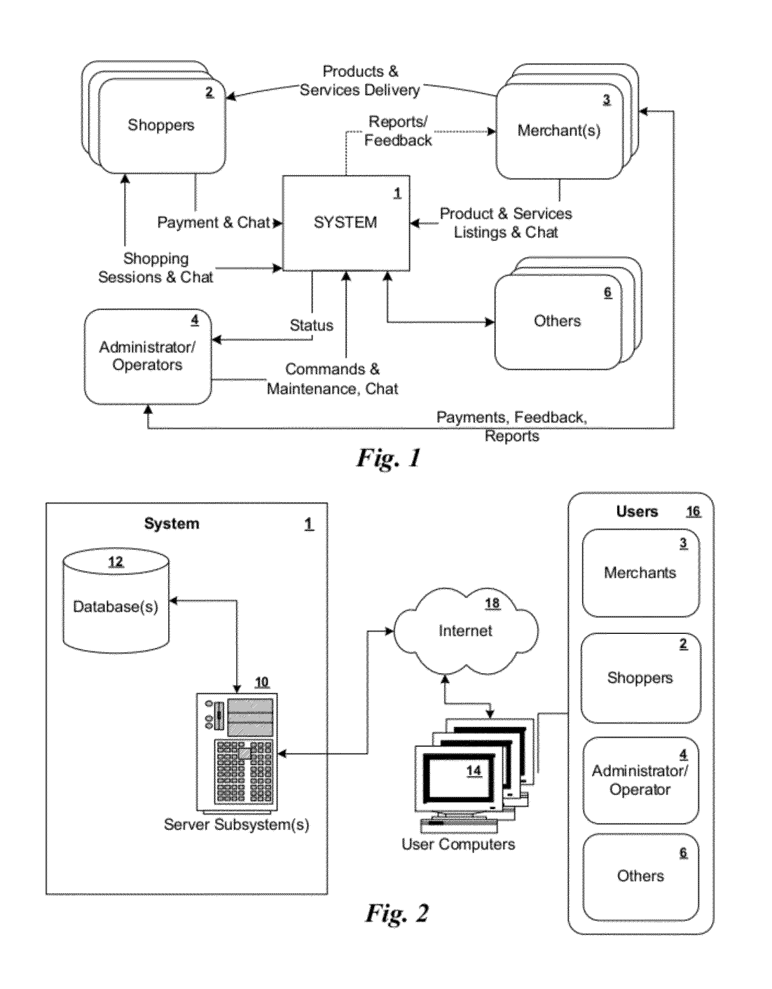

In some embodiments, the client (merchant) can download executable code that can be directly implemented into their website to implement the shared shopping functionality. In order for the merchant to receive the benefits of this software, it needs to be registered and billing information needs to be taken, so that the merchant can pay the appropriate fees to the code provider. This is code should not be altered without the permission of the owner. Each code will have a unique identifier that allows each customer to distinguish themselves from other customers. This type of system is described below in more detail with respect to FIG. 1a.

In other embodiments, a centralized system provider could host the service and provide a snippet of code to be inserted directly in to the code of the websites of existing stores. This could be done at through the web browser. Or, alternatively, the stores could be hosted on a centralized system, such as shown with respect to FIG. 1. Furthermore, still other embodiments could utilize combinations of these models, varying the amount of functionality that is provided centrally, and the amount of functionality that is provided by distributed (e.g., merchant) sites.

FIG. 1 shows an example high-level diagram of the primary participants in an example embodiment, where most of the functionality is provided in a centralized system. In this case, the primary functionality of the shared shopping system is represented by the system 1 block, which interacts with the primary external entities, the shoppers 2, one or more merchants 3, an administrator/operator entity 4, and other entities 6 (such as suppliers, government agencies, etc.). At least some of the functionality could be offloaded to one or more merchant

The shoppers 2 represent a plurality of shoppers who interact directly with the system 1 by receiving shopping sessions where they can shop online for products and services and otherwise interact with the system (by creating and administering their accounts, for example), and by providing payment to the system when they check out. These shoppers can shop individually, or they can shop as part of one or more groups while socializing with others in the groups, as described in more detail herein.

In contrast, the merchants 3 provide the system with product and service information for the products and services that the merchants wish to provide for the shopping experience. Merchant websites may provide limited real-time functionality in support of this shopping in some embodiments. The merchants 3 also communicate with the administrator/operator of the system to provide feedback about the system, to contract for use of the system, to communicate operational details, and to pay for their use of the system, for example. The administrator/operator may also provide the retailers with various reports about usage of the system 1. Alternatively, such reports may be generated by the system 1 itself, and perhaps automatically sent to the retailer.

The administrators/operators 4 are responsible for maintaining and operating the system, and receive payment for others use of the system, such as by receiving a commission, monthly usage fee, or some other method of payment from the merchants 3 as discussed above in more detail. The administrators/operators 4 also receive feedback from the various users, such as, for example, improving the system or increasing its capabilities or adding additional features. The merchants 3 may participate in shopping sessions by providing sales chat functionality to answer customer questions, discuss products, offer product suggestions, etc., as discussed in more detail above. Administrators/operators might also provide chat sessions to support shopping, such as by answering technical questions about the system, or as a service in lieu of the merchants providing such capability.

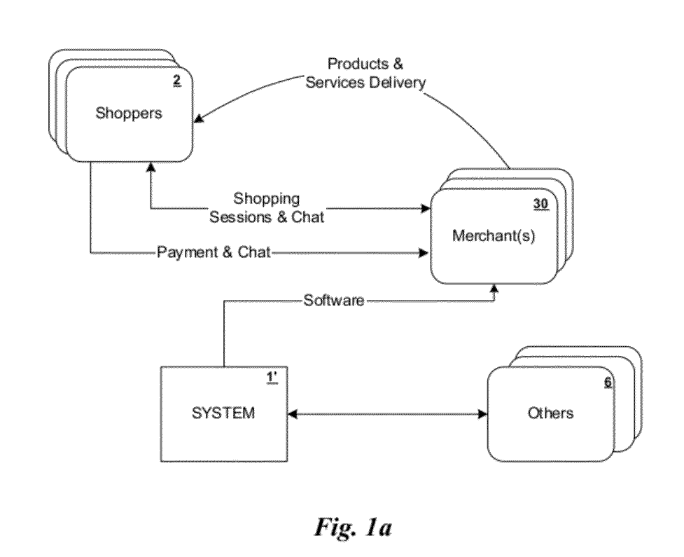

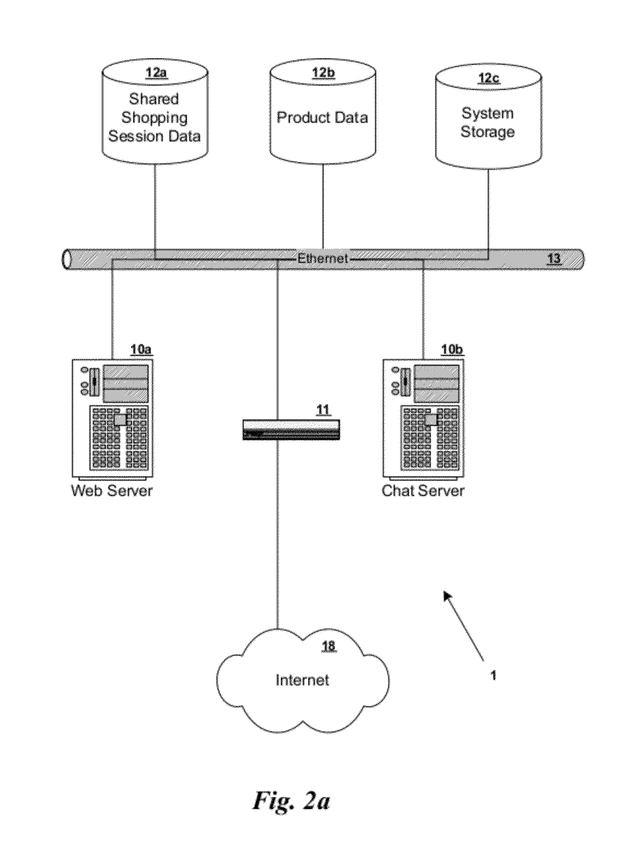

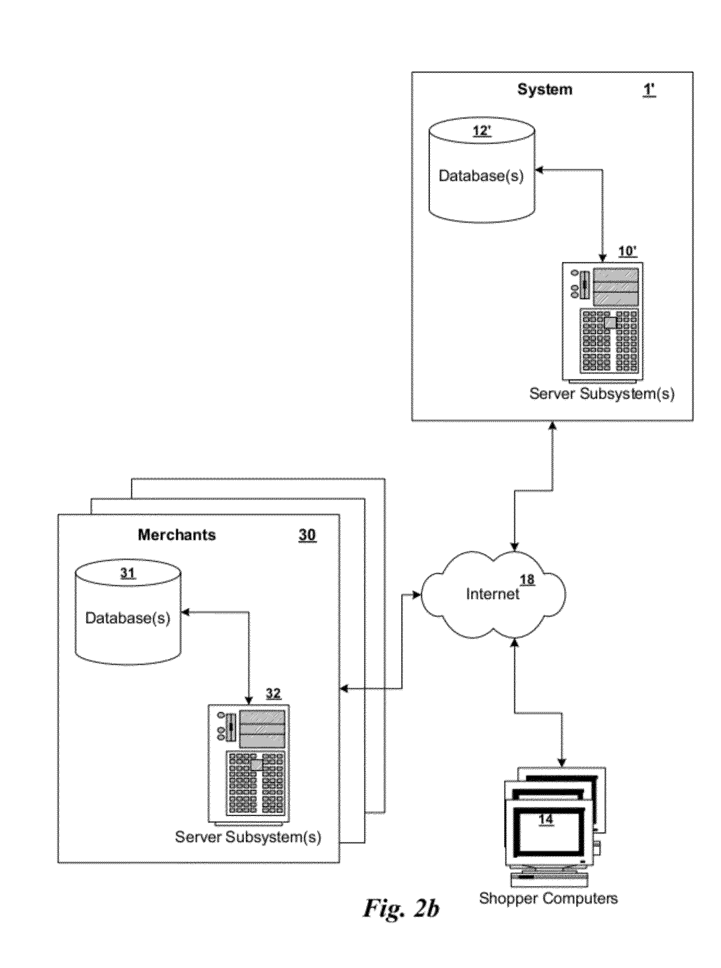

FIG. 2 shows one example hardware implementation of the system of FIG. 1, among others. The system 1 can be implemented using one or more server subsystems 10 communicating with one or more databases 12. The system 1 is connected to the Internet 18 by a typical manner, such as via a firewall router, for example. The users 16 access the system by using their own user computers 14, which may be simple personal computers, or more complex servers that connect to their own databases, for example. In particular, the Merchants 3 may utilize more complex computer equipment to interact with the system 1, as desired. Other networking solutions other than, or in addition to, the Internet could alternatively be used.

FIG. 2a shows an example embodiment of the system 1 hardware in more detail. Such a system will likely have a web server 10a and a chat server 10b (that may run on the same hardware, if desired). Such servers can be implemented using standard COTS server computers, such as are provided by HP, IBM, or Dell, for example, running a Windows, Linux, Unix, or other commercial operating system. Standard web server applications, such as MS IIS, or Apache Server could be utilized for the web server, and a commercially available chat server such as LlamaChat, OpenCHAT, Ace Operator, FreeCS, MSN Chat, or another chat server could be used to provide the chat server function.

A number of databases can be utilized, such as a shared shopping session database 12a, a product data database 12b, and a system database 12c. These databases, which may be implemented on a single, or multiple, computers (including integration with the web and/or chat servers discussed above), could be implemented using any commercially available database, such as MS SQL, MySQL, PostgreSQL, Oracle SQL, or some other SQL or other paradigm database software could be used.

The database(s) and server(s) of the example embodiment of FIG. 2a are networked together (if multiple servers are used) by a standard computer network, such as an Ethernet network 13, which is connected to the Internet 18 via a router and firewall 11. However, if desired, intranets or other communications networks such as cellular networks could be utilized instead of, or in combination with, the Internet 18, for connectivity external to the system 1.

Customized executables and scripts (that may be saved in the system database 12c, for example), some that run on the server and others that are downloaded to the user computers (or even merchant computers) for execution thereon, can be utilized where desired to provide the desired functionality. The system can utilize various browser-based plugins, such as Flash or Java, as desired, to obtain the desired functionality at the user end, when such users are to use commercially available browsers, as discussed in more detail below. For such a system, the users typically interact with the system using their own computers running commercially available web browsers (such as Firefox, Chrome, Safari, or Internet Explorer).

An alternative structure is shown in FIG. 1a, where one or more merchants 30 who participate in the shared shopping manage their own shopping sites, but utilize plug-ins from the system 1′ that implement the shared shopping features. System 1′ can also provide centralized functionality, where desired. In this embodiment, rather than using the system 1 of FIG. 1 with most of the functionality being centralized, the shoppers 2 shared shop utilizing the individual merchant sites 30 that are adapted for the shared shopping through software modifications or plug ins. Implementations of these individual sites can be similar to that described above, but using the hardware setup shown in FIG. 2b, with merchant sites using their own databases 31 and server subsystems 32. The system 1′ can also utilize its own server 10′ and database 12′, as desired. The individual shopping sites operated by the merchants 30, and/or the system 1′ might utilize the setup shown in FIG. 2a, for example.

In this alternative embodiment, each merchant 30 operates its own shopping site with the shared shopping software (such as plug ins) obtained from the system 1′ and installed on its servers 32. Centralized functions can be provided by the system 1′ servers, if desired, such as providing interaction between the merchants 30 to provide online shopping malls, and/or for providing some of the shared functionality, for example. As much or as little of the functionality can be centralized in the system 1′, as desired, to the point that the functionality of the system 1′ approaches that of the system 1. Alternatively, in some embodiments, all of the functionality may be implemented on the merchant servers such that the centralized system 1′ merely provides the necessary software and updates to the merchant computers, as necessary, with little or no real-time interaction in the shared shopping.

Note that cloud-based implementations could be utilized, where the servers and/or databases are not located in a facility owned or operated by the administrator/operator or the merchants, but are instead hosted by a cloud-based service, such as provided by Amazon, for example. In such a case, the design of the system may be outside of the control of the administrator/operator, who may not even know the exact design. However, the custom software needed to implement the system would be controlled and uploaded by the administrator/operator to the cloud-based host.

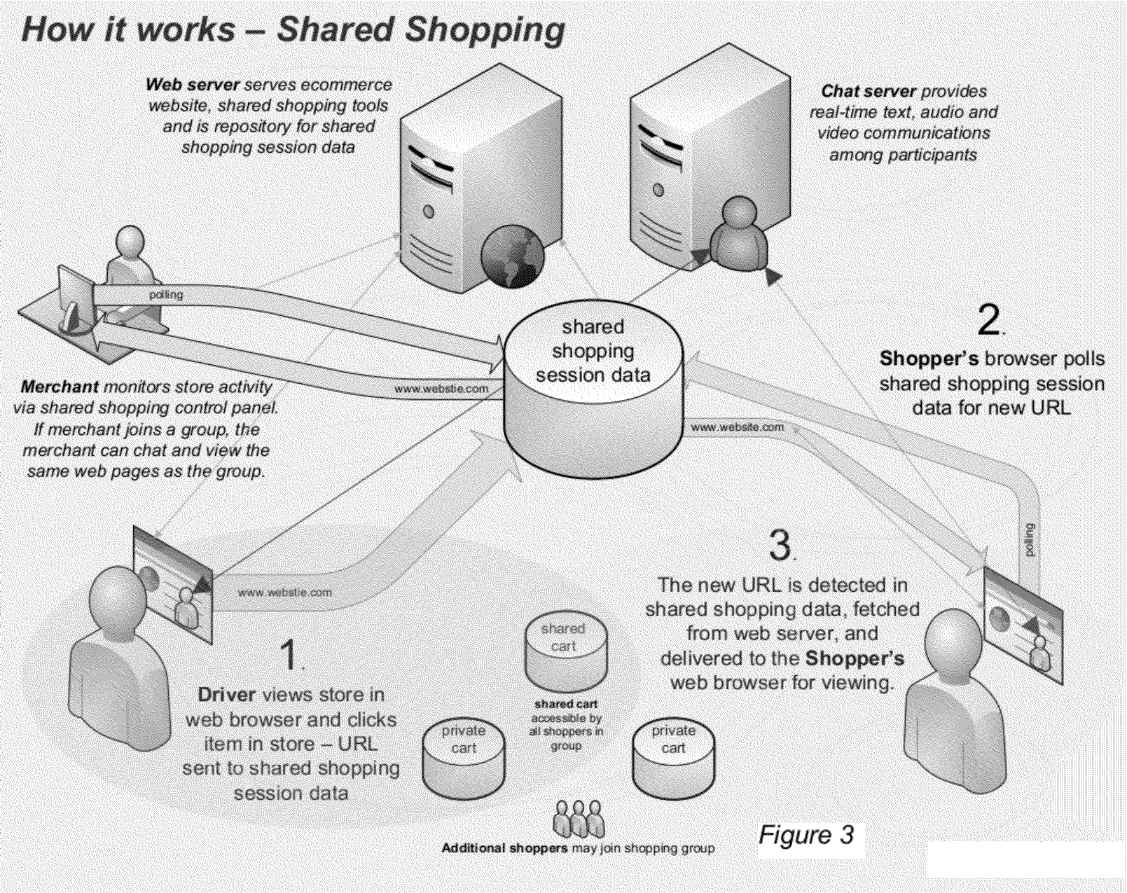

FIG. 3 shows an example of the process of executing a shared shopping session in an example embodiment as shown in FIG. 2a. (1) The initiating user, the driver 2a, initiates a session for viewing the storefront provided by the system 1. By clicking on an item in the “store”, the URL of the item is sent to the system to be stored in the database 12a. (2) The browser of another shopper 2b that is jointly shopping with the shopper 2a, polls the shared shopping session data for updated URLs, (3) When the updated URL is detected by the browser of shopper 2b, the URL is utilized to display the item represented by the URL to shopper 2b for viewing. The items can be placed into the personal cart 101 of shopper 2a, by shopper 2a, into a shared cart 102 by either shopper 2a or 2b, and/or into the personal cart 103 of shopper 2b by shopper 2b. Any number of additional shoppers 2c˜2n can similarly participate. A merchant 3a, 30a can also participate by monitoring the activity of that merchant's store, and provided chat support for the shoppers, if desired. The shoppers 2a˜2n can also chat with each other via the chat server 10b of system 1 (or system 1′) to discuss the shopping experience (such as to discuss the viewed product), or for some other purpose.

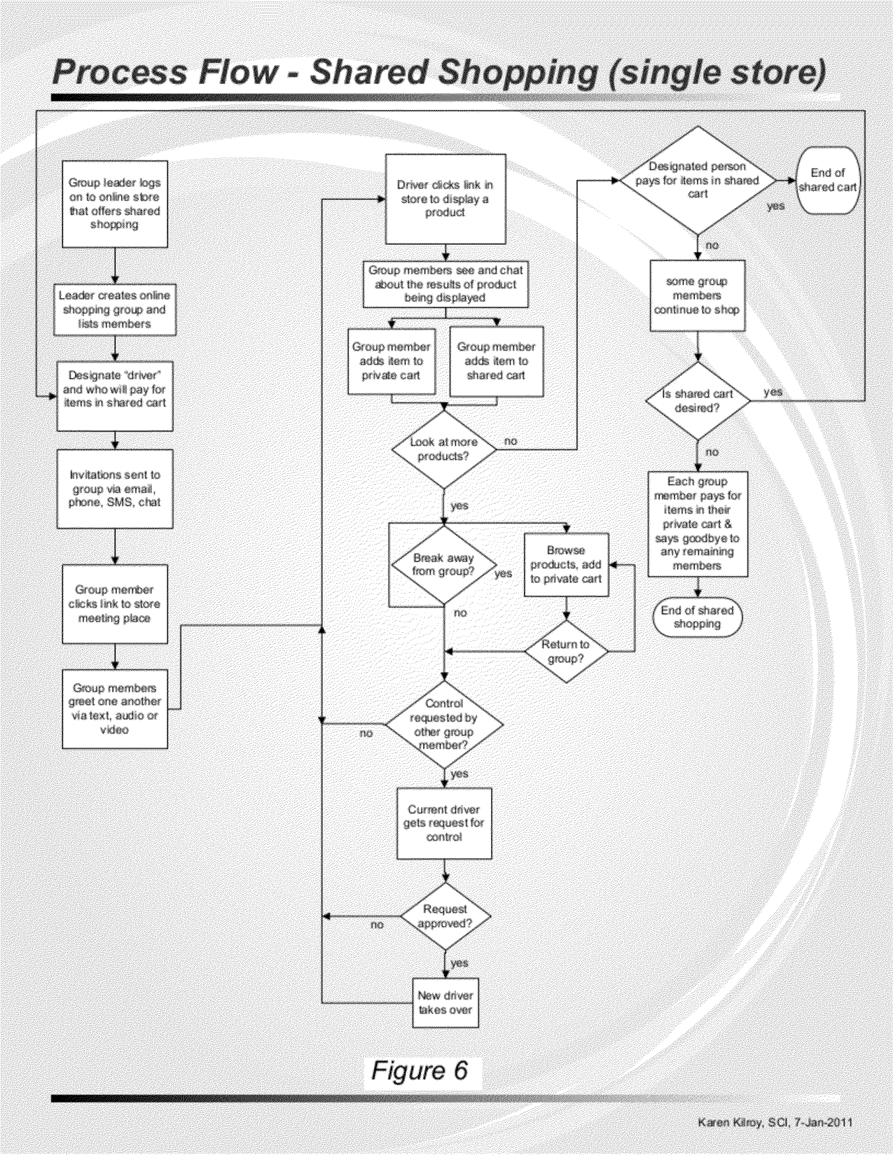

FIG. 6 is a flow chart showing an example single-store shared shopping process utilizing a driver that can be utilized to implement a number of the features discussed in this application.

The shared shopping session data is frequently polled. A new URL is fetched by all client browsers of the shared shopping group, which displays the document referred to by the URL on their screens. Alternately, a push technology could be used that would push a new URL from the shared shopping session data to the client browsers.

The client browser is a somewhat unpredictable factor. The shared shopping application is adapted to function properly on as many browser platforms (e.g., MS Internet Explorer, Firefox, Google Chrome, Apple Safari, etc.) and versions as is practically possible. The client browser is used to initiate the request to visit a page in a shared shopping group, and other client browsers are used to poll the shared shopping session data which in turn invokes the results of a hit to a URL to appear on the shopping groups' client browser screens.

Shared shopping session data and shared shopping mall data may be stored on the system web server (10, 10′), or it may be stored on a client (merchant) computer (14, 32), or both. Future plans would be to distribute this data as needed, including utilizing cloud computing and peer-to-peer solutions.

Adding shared shopping to an existing store or website is accomplished by adding logic to the store or website that allows visitors to form ad-hoc browsing groups which are private to other visitors. Logic for real-time communications among group members is also provided. This logic can be added an existing ecommerce platform by enhancing its framework. Logic such as this is typically sold in the form of platform-specific plug-in modules. The specific programming language and techniques used to write the plug-in module varies according to the specifications of the platform for which the plug-in is intended. These modules can be provided by the system 1, 1′, for example.

Mobile Applications

Mobile applications can be supported and therefore are applicable to this process. Devices include, but should not be limited to, cell phones, smart phones, Personal Data Assistants, Tablets, iPads, netbooks, smart TV, streaming devices, or any other mobile computing or communication device that exists or will exist. The technology could be accessed by the following but is not limited to: a browser add-in, a mobile platform application, a social site, etc. Both of these could be downloaded to the said device and run the technology. The download is not limited to a United Cloud or shared shopping download, as it could be licensed out and placed on an store application. An example of this would be the Ebay app for Android platform or the Tiffany & CO app for the Apple devices. However, it is not limited to these platforms.

In the case of the shared shopping mall, where shared shopping is available across multiple stores, logic could be created to provide a conduit to connect the stores, provide logic to manage the stores, and provide common services to the stores such as shared shopping.

This can be done in at least two ways: A) For stores and websites which exist across the same platform, a plug-in can be provide to add shared shopping mall functionality to any store that exists within a single implementation of that platform. This could be represented by FIG. 1a where only one merchant is participating, in which case the system 1′ may not participate in the shared shopping functionality, other than to provide the plug in (or may provide a substantial portion of the functionality, with limited functionality being provided by the plug in). B) For stores and websites that exist across multiple ecommerce platforms, a conduit can be provided which provides a shared shopping mall API to which stores on most other platforms can connect. In FIG. 1a, a server of system 1′ (as shown in FIG. 2b), could provide such a conduit.

System 1 of FIG. 1 could alternatively be utilized where all shared functionality is centralized.

The shared shopping mall API provides the conduit which provides shared shopping utilities and other useful functions to the mall tenants. This shared shopping mall API/conduit also connects the elements of the mall. This typically includes:
Connecting the stores, so the shoppers and shared shopping groups can wander among the stores;
Connecting the common areas, including the mall social network, the extra attractions, the non-ecommerce tenants; and
Provide a hook to the mall management functionality.

The shared shopping and shared shopping mall functionality can be provided to run on a wide variety of ecommerce platforms. It can be a client-server application that does some of its processing on the back end, and returns results to the client (shopper), which is typically a web browser or a smartphone application, for example.

Although it could be varied according to the specific application, the shared shopping application runs on typical web server hardware along with a website (such as a merchant website in the embodiment of FIG. 1a), or it is distributed to its own dedicated web server for high volume situations (such as a centralized system of the embodiment FIG. 1), or any combination in between. The web server software that is used can utilize commercially available web server hardware and software with a configuration typical for that particular ecommerce platform.

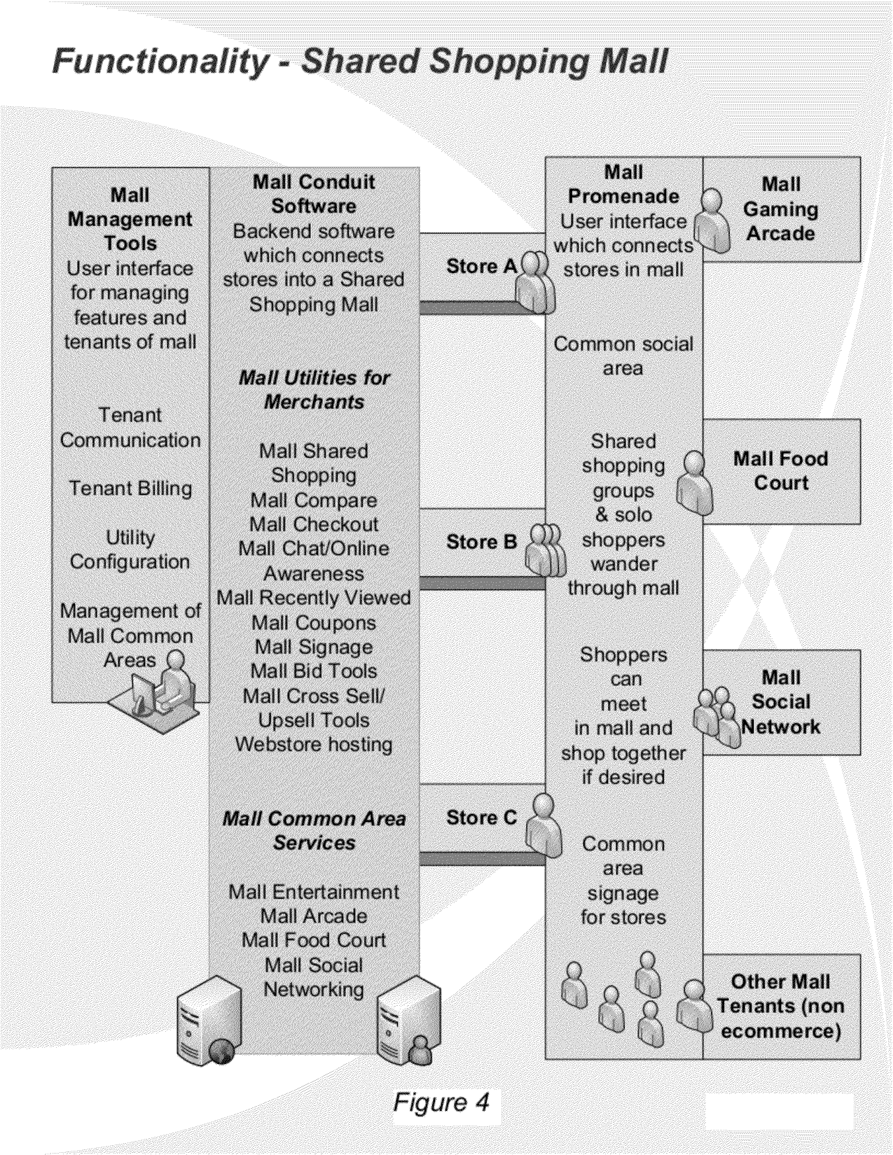

FIG. 4 shows in some detail the software functionality of an embodiment of a shared shopping mall that could be provided by the system 1, supporting a plurality of merchant stores A, B, C, with shopping tools. The diagram describes the ways shared shopping can be incorporated into a traditional shopping mall scenario. Imagine shopping in a mall where the shopper can check out remotely. Shopping malls tend to have similar features, such as gaming, food, and shopping, for example. Traditionally, a person walks through the mall and stops at stores that interest them. This can be similarly done online. For example, a mall website can be created that lists the same basic stores that correspond to like stores in the physical mall. Shoppers click on stores to visit online that interest them. This is equivalent of shoppers walking into a store.

The Mall management tools section is typically controlled by the mall owners, not the merchants, who are often different parties. The mall owners use this part of the module for managing tenants of the mall (e.g., the merchants). This also could be used for communicating with vendors, and billing vendors electronically. This module of the software therefore provides a means for mall owners to communicate with tenants and to implement financial channels, for example.

The Mall Conduit Software is the software that connects all stores to the mall owner. This could be done at an API level.

The Mall Utilities for Merchants—These are online services offered at the mall level. For example, “mall coupons” could be a special offer where its 10% off the total cart value.

The Mall Common Services area is an area that is specific to the mall but not specific to merchant stores. This might include informational areas, for example, or store listings, or other information that is useful to be centralized.

Shared shopping involves providing social groups (whether based in the real world, or online, or both) the ability to share shopping experiences. As discussed above, groups can be connected through intermediary services, such as social media. For example, inviting friends can be done by shooting the URL through Facebook, for example. In essence, Facebook, can create URLs and have multi user chat functions, such as how they can be set up for the magento platform (described in more detail below). Opengraph technology allowing users to sign in with social media accounts could be utilized.

VOIP can also be used to connect groups. One example of this protocol is SKYPE. In the most adaptive shared shopping paradigm, all mobile and desktop devices will be extended to have the ability to do video chat and video calling, as many currently can do. This is not to say that VOIP will replace the existing communication. Merely, this is another way of groups connecting together. Another example includes “Facetime” from APPLE. This is just another way of getting people connected to carry out the process of shared shopping.

System Configurations

There are many ways this shared shopping application can be configured. For example, the applications can be configured based on the platform upon which it has been employed. Beyond that, there are additional ways to configure the shared shopping application and shared shopping mall application. Some examples are:
Shared shopping application—frontend: This is where visitors to the shared shopping store or mall can create and configure new ad-hoc groups, check in with existing groups, join in public shopping ad-hoc groups, or regularly scheduled group shopping clubs. This is configurable in the sense of setting up groups, creating member lists, issuing invitations and tracking responses;
Shared shopping application—backend: The backend of the shared shopping application is configurable in a variety of ways that control items such as the location of the shared shopping session data, the options that are available to a particular group of shoppers, default settings for those options, current and past visitor historical data, special settings for shared shopping clubs, and other items that impact the overall behavior of the shared shopping application;
Shared shopping group member control panel—frontend: The shared shopping experience can be customized by a particular shopping group by group leader, for example, or for an individual by the group leader or the individual shopper. This configuration includes identifying the “driver” of the shared shopping experience, intercepting and processing requests for a change in drivers, who will pay the bill on the shared cart items, who is allowed to see the shared cart, and settings for real-time communications among the shopping group;
Shared mall application—backend: The shared mall application is configurable from a backend administrative control panel that allows the mall manager to determine which tenants have paid rent, set up and manage common areas, set up which utilities are available to all mall tenants and install and configure new utilities, set up payment plans where mall tenants can pay an additional fee for enhanced utilities; set up non-ecommerce tenant presence; manage default settings for mall signage, ads, coupons, and configure mall auction capability;
Shared mall application—This is used by the shared shopping mall visitor to customize their shopping experience. Settings may include: visibility to other shoppers; types of stores they would like to see in the mall (a filter by price range or type of retailer); their mall-wide multi-store services such as items recently viewed; items to compare; shopping cart; bookmarked items; and other items particular to the shared shopping mall user experience;
Shared mall management application—frontend: This is an administrative control panel used by the shared shopping mall manager to coordinate activity among the mall management and the tenant. This can include charging the tenant rent, adding services to the tenant's store, moving the tenant's location in the mall, taking payment for advertising and signage to be placed within the mall by tenants and other advertisers; and other things pertaining to the nature of managing a landlord/tenant relationship for an online store in a shared shopping mall; and
Real-time communications server configuration—backend: This is configurable to set items such as which forms of real-time communications are available, and specific configuration pertaining to the technical settings of those real-time communications platforms.

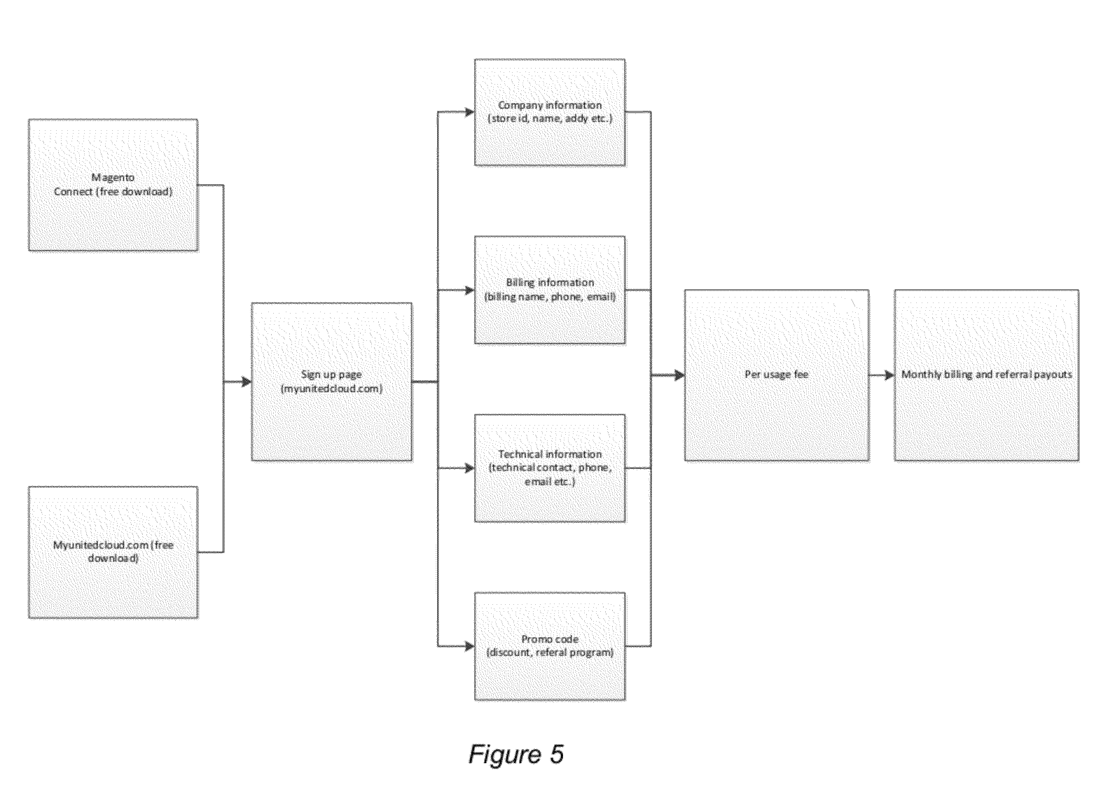

FIG. 5 shows an example of a registration process for a merchant to sign up to participate. Clients (merchants can contract to implement shared shopping features by first downloading the appropriate installation module either from a centralized system site, or the Magento Connect site. Upon downloading the clients will be directed to a sign up page on the system site.

The sign up page on the system site will ask for company information, billing information, technical information and a spot to enter a promo or referral code which will allow the system provider to pay a referral fee to partners and track promotional strategies and ads.

Once the sign up process is completed successfully, clients will agree to the pricing structure (e.g., a “per usage” fee) and billing requirements. Upon completion of this process the client will gain access to install the module on their site.

For configuring the operation of the shopping carts, a number of alternative implementations can also be utilized. For example, an approach can be used where one person is designated as an “owner” of a shared cart, with such a person having more authority/control over the shopping session. Alternatively, in a simplified shared shopping session all shoppers may have equal rights and control over the session, and/or the shopping cart.

Screen following is primarily utilized for the simplified approach where all shoppers have equal cart rights. A popup box allows a member of a group to select which screen to follow. This way, no one person has any unique control over the shared shopping cart. Items are placed in the shared cart where everyone has equal abilities to add items and check out, for example. Their abilities include paying for it, or not paying for it. The abilities include choosing to be part of the group or to not be part of a group. Also, using the communication lines or not using the communication lines. Distinct roles including purchasing, approving, authorizing, auditing, and others are avoided in this scenario. The shared shopping experience provides equal abilities and roles that are implicitly granted to all members in the shopping group. Everyone has the same ability to affect the shopping basket. Furthermore a shopping cart is treated as a placeholder. Items in a shopping cart still belong to the store until the items have been purchased. So who owns the items in the shopping cart? The people that purchase the items in the cart do.

System Integration

While the application invoking shared shopping functionality can use a client server or a peer-to-peer scheme for storing shared shopping session data, system integration among the client and server, or among the peers, is similar to that which is required for typical web browsing. Outside of this, system integration hooks are provided via the shared shopping mall utility APIs, which are described in the Technique section of this document.

Additionally, hooks may be provided via the shared shopping mall API that allows integration among Tenant's internal systems and the shared shopping mall management utilities.

Example Shared Shopping Group Creation

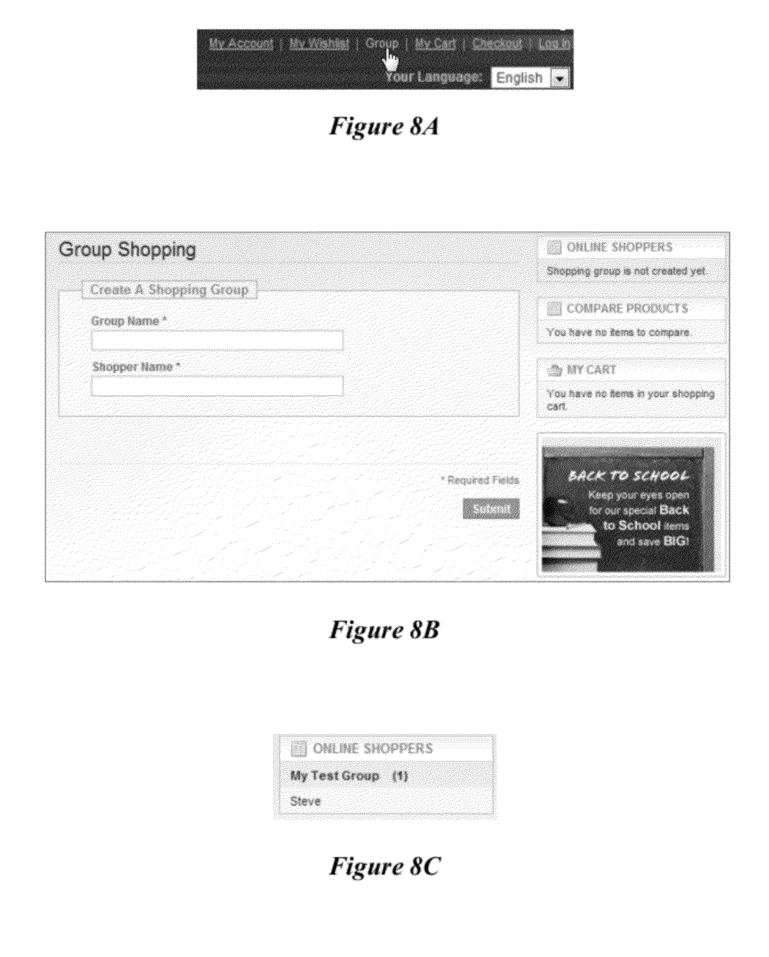

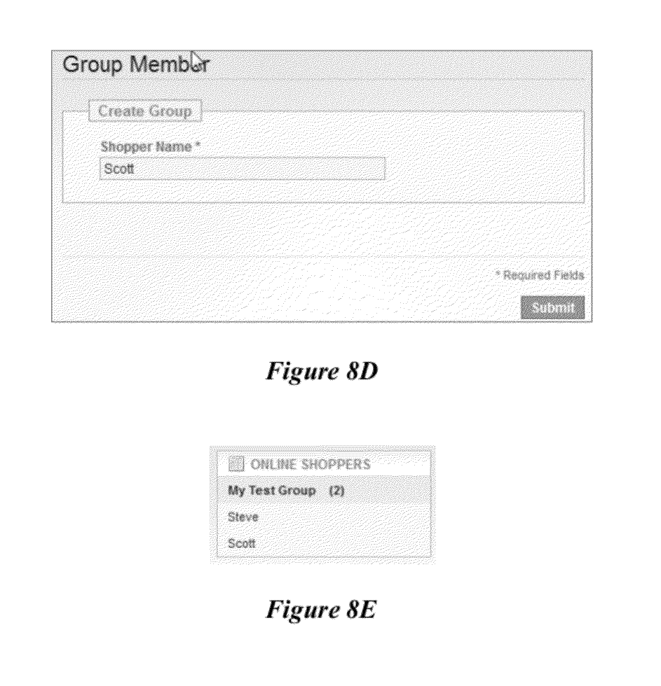

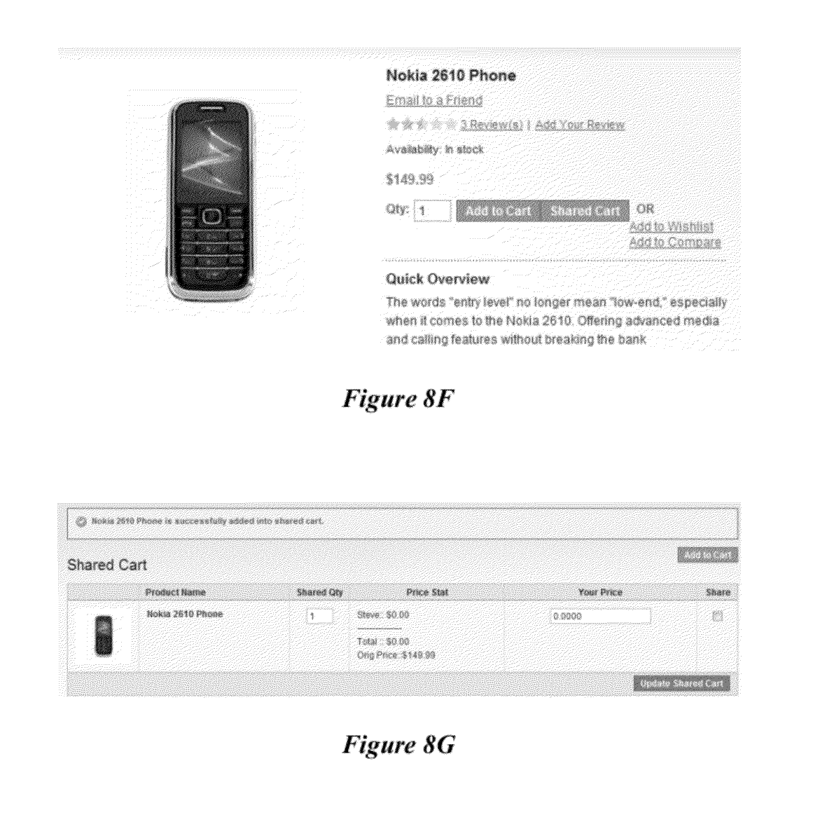

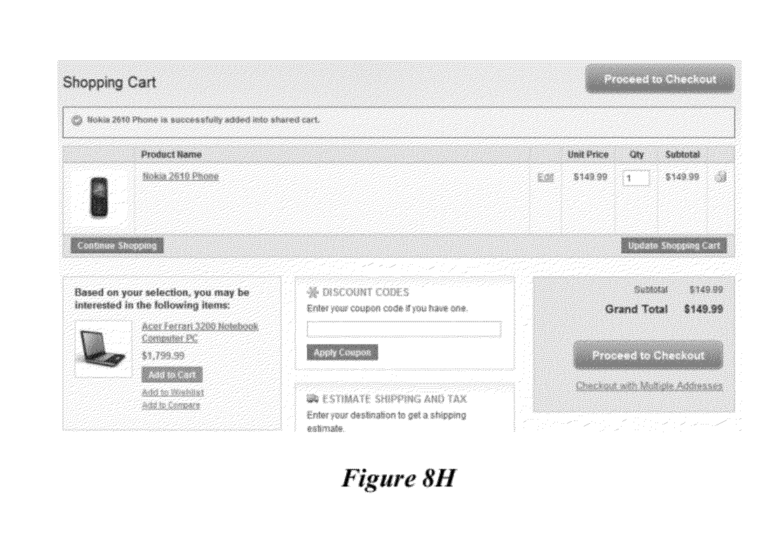

As an example, a group can be created through a Magento form. A user selects ‘Group’ from a set of links which may be shown at the top of a page, as in FIG. 8A. This figure describes how users create a shared shopping group. A user that desires to create a shopping group can do so by clicking the group link prompting FIG. 8B. The user is provided with a form such as shown in FIG. 8B to create the group. Using this form, the user creates a shopping group by filling in the required fields. At this point the usage count has been increased because a shopper has successfully completed the required information to create a shopping group. An API for group creation will be exposed via a SOAP-based web service that will allow any outside or third party platform to interact with the Magento code, including the chat bar that is currently being developed to accompany the Magento Shared Shopping module.

FIG. 8C: Shows the user that is a member of the shopping group by showing the group name. This item also shows the name of the shoppers in the group. Currently in this figure there is only one shopper in the group.

As a further example, a user can enter a desired group name and the name the user would like to be identified with, such as shown in FIG. 8C. Upon group creation, a unique URL will be generated that can be sent to whomever has an invitation to join that group, such as: www.bignameretailer.com/dev/magentolive/index.php/sharedgroup/index/memberform/id/Nw==b523ff/.

An example process for group creation would be:
The group is created via live chat bar;
Invitations are sent from the chat bar to various email addresses of users who have been invited to the group, with an email being sent to the invited people with the unique URL that will allow those users to become members of the group;
Both the chat bar and the Magento piece should be synced up as to the active groups and active members of those groups;
Once a user clicks on the unique group join invitation, that user will enter his name and then become a member of that group.
FIG. 8D: A gateway is provided to invite additional shoppers to the group, URLs can be sent through chat, email or other means of communication. Once the URL is received, FIG. 8D shows a prompt provided once the link in the communication is clicked. This is where other shoppers can input their name and join the group.
FIG. 8E: Confirms the success of shoppers joining the group. Once shoppers are in the same group they can share the shared cart and shop together. Note that this figure shows two shoppers are now part of the group.
FIG. 8F: This is an example of what a product may look like. Notice there are two shopping cart buttons. A personal add to cart button and a shared cart button, allowing a person to add items to either cart.

The shared cart is typically set so that it works once a group has been created, and members become members of that group. The member that creates the group is considered the driver, and the members that subsequently join are considered passengers. Both drivers and passengers can add to their carts items for a personal shopping experience, or they can also both share items with each other. Typically, both are given the ability to invite others to join the group.

Within the context of Magento, all product types can be shared. Group members will utilize the chat component to communicate ideas of items to purchase and share, and through screen sharing technology, be able to keep all members of the group in sync and on the same page.

For example, a person deciding to share an item will go to the product detail page, select the quantity of the item, select any desired options associated with that product, and then select ‘Share Product’. The item gets moved to a holding area known as the “Shared Shopping Cart.” From the “Shared Shopping Cart,” the person that shared the item can check the box to share it with others, change the shared quantity, and determine how much of a contribution the person would like to make to that product's total price. FIG. 8F shows an item with the choice of selecting adding to a personal cart, or a shared cart.

Once the item is chosen to be shared, all group members can view the item within their shared shopping cart and decide how much they wish to contribute to the overall cost of that product. The look and feel of the shared shopping area will look very similar, if not the same, as that of the shopping cart shown in FIGS. 8G and 8H. Looks of the cart may vary based on user settings or the browser used, however,

A more robust negotiation system can be provided under each line item that allows members to enter a dollar amount or percentage of the contribution that the user wishes to contribute. A product will not be allowed to be added to the shopping cart until all the total cost of the particular product is squared away and covered, upon which the ability to add the shared items to the shopping cart will be allowed.

As an example, behind the scene, the person who shared the item will be the main provider of that product. The additional members will be adding a “dummy” product that represents the contribution value they offered for that particular product. The real product shipping information will typically be determined by the member who shared the product, however. From here on out, the process follows the normal Magento flow, where members check out and pay through the normal process, as defined by each merchant.

Split Payments Example Scenario

An example of the split payment scenario is provided: After the user clicks on the shared Checkout link the following steps can be utilized:
1) The cart can be locked where no more items will be able to be added to it from other users in the group. “Add to Shared Cart” buttons will be replaced with grayed buttons, hovering over the button can reveal text that informs the user that the cart is in the checkout process because a “Specific User” is starting the checkout process.
2) All other users in the group can be sent a chat notification stating that the shared cart is being pushed to checkout by another user. This gives all members of the group a chance to ask the checkout initiator to hold the transaction, if need be.
3) The user that clicks on the shared checkout button can be forwarded to an approval page to approve the items in the cart. The user may then take one of at least three possible steps: (a) The user might leave the page either by hitting the back button or closing the browser; (b) The user may continue shopping; or (c) The user may approve the items that are in the shared cart. For example:
   Option 1: If a user leaves the approval page or hits the back button, then the approval process will no longer be initiated and the cart will not be locked anymore. A script will run to detect if a user closes there browser. The function loads and is run before the browser shuts down;
   Option 2: If a user decides to continue shopping, then the approval process will no longer be initiated and the cart will not be locked anymore. A user would decide to continue shopping by either clicking on a “Continue Shopping” button, or by clicking on a link on the page that navigates the user to another portion of the store. Then a function will run to upload the page unless the user is navigating further in the checkout process; or
   Option 3: If the user approves the cart, then all other members of the shopping group will be sent a chat message notifying them that they need to approve the cart and proceed to the checkout.
4) After an elapse of a certain amount of time, members that have not approved the cart will be sent a message and/or a corresponding email. Both methods will have the cart URL attached to enter the checkout process.
5) In some embodiments, when the “initiator” of the shopping group (e.g., driver) goes to the approval page, that page will have more options on it. There will be a list of all members of the shopping group, and next to their names will be input boxes with default percentages. Next to the percentages will be text that displays the dollar amount. Alternatively, all members might see the same information. For example:
   1/number of users in the shopping group=default percentage that members are responsible to pay for;
   The total cost of the cart times the percent in the input box equals the cost that user will need to pay for their portion of the cart;
   Alerts should be given if percentages do not total 100% of the cart; and
   All dollar amounts should be rounded to the nearest penny, remainders that can't be split will be allocated to the initiator's portion.
6) When any member of the group has approved the cart, he/she will be forwarded the payment page where they will be asked for payment information.
7) After submitting his or her payment information, a member is sent an email stating that the payment information has been received and will be processed once all other member of their shopping group have entered their payment information. The email will also urge the user to remind their friends (other members) in the shopping group to input their payment information in a specified time window (members can do this via chat or other communications channels that may be provided by the shared shopping system). The mail should include all the names of the users in the shipping group, as well as their email addresses. Also, after submitting their payment information, all users should receive a message saying they received a message confirming that each member of the group has paid.
8) All users that have not submitted their payment information after the elapsed time window will be notified to submit payment information immediately.
9) A time interval will pass before the next notification is sent if a member still hasn't paid for the items. This can be repeated any number of times, within the designated time window.
10) All payment information will be sent to the proper processor upon arrival. A token will be granted and sent back. Once the last member of the group submits his or her payment information, all tokens are processed.
11) If one or more members fail to enter payment information within the time window, notifications will be sent to members with a link to the checkout process, such as by email notification or chat, for example.
12) Once all payments have been received from the members (totaling the purchase price including all fees), a confirmation email will be sent out to all of the members affirming that all members have made their payments and that all payments have been processed. The message can confirm the items in the cart and the shipping address, if desired.

If a user has already approved the cart, then when that user views his or her shared cart, it will show the items in their cart as well as a notification stating that other member in the group must approve the cart to proceed. Along with this there could be provided a button that a user can click that says “I want to continue shopping.” This would allow the user to only add items to his or her personal cart. If the user clicks on this button, then that cart is no longer in a “holding” status and it will be open to allow users to modify it.

A cart status can be provided to the shoppers, with a link to the cart. While in a “shopping” status, the link will show the shoppers the items in the cart, and allow them to remove items or change quantities (or add items). But when in a checkout status (as chosen by one of the shoppers starting the checkout process), the cart is frozen and cannot be modified, and the link then directs the member to complete the checkout process. When the cart is in the checkout status, all “add to shared cart” buttons should be grayed out, and become inactive. Hovering over the button can tell the user the status of the cart, and that items cannot be added to the cart because of the checkout process being invoked.

At the end of a shared shopping session, the bill for the shared cart can be split among the parties evenly or by certain amounts or percentages.

Revenue Streams

Shared shopping attracts consumers. Shared shopping will be used in our stores, which will attract consumers based on ability to shop in a social manner, thus creating a buzz and increasing the profits of the store.

Shared shopping is a social experience and generates ad revenue. Shared shopping fosters a collaborative back-end social network based on common interests of shoppers, and will be used in our existing malls to generate advertising revenue.

Shared shopping malls generate rent. A shared shopping mall will generate revenue from current mall tenants.

Shared shopping sales and service can increase revenues through interactive selling and up-selling. Since shared shopping salespeople have the opportunity to directly interact with shoppers and guide them through the merchandise, this increases the opportunity to sell the product on its merits rather than on price alone, as well as to interest the customer in related or upgraded items.

Shared shopping can generate revenue via clubs and personal shoppers. Shared shopping clubs could have associated dues which would generate revenues for the club. Personal shoppers could lead shared shopping expeditions for which there is an associated fee.

Shared shopping software can be sold commercially, either stand alone or as a service. The shared shopping application can be sold for use by others in their own stores and malls. It can be sold in at least two forms:
Shared Shopping Mall Module—for Multiple Web Stores on a single platform: This is a plug-in module for specific ecommerce platforms, such as Magento, and can be sold via existing channels for ecommerce platform add-on packages; and
Shared Shopping Mall Utility—for Multiple Web Stores on Multiple Platforms: This is a mall conduit for stores on multiple platforms which can communicate via common web services. This utility will come complete with the ability to manage mall tenants who pay rent. This utility provides an interface to common areas and utilities that are provided by the shared shopping mall web services. These utilities can include, but are not limited to: shared shopping carts and other shared shopping features as described above; shared cart that can be used for all stores in the mall; shared compare that can be viewed by multiple shoppers and can compare items from different stores in the mall; and a one-stop mall checkout.

Additional Methods and Uses:

The “driver” of the shared shopping session can be in the physical brick & mortar store, and the rest of the ad-hoc shared shopping group can be online at various physical locations, or also at the store. The “driver” (or another shopper) can scan a bar code or read an RFID tag of a physical item in the store using a mobile device, which will cause the corresponding item from the merchant's website to automatically appear on the screens of each member of the shopping group. Other technologies such as Bluetooth can be utilized for such connectivity. In such a scenario, payment and/or pickup of the actual item could be made in the physical store, or online for users who are not present at the physical store.

Ad-hoc shopping groups can also form, with some shoppers in-store and others online. Shoppers can choose whether or not to make their presence and interests visible to other shoppers and store clerks. This way, two or more people could convene at a particular item, already aware of the other person's interest, and discuss the merits of the item. A sales clerk in the store could “see” on the store's shared shopping control panel that there was an in-store ad-hoc group shopping together, and the clerk could decide whether to offer assistance, such as in person, or online.

Cost of items in shared cart can be divided among the shared shopping group or paid for by one designated shopper.

The shared shopping and shared shopping mall applications are business process innovations which reflect the collaborative nature of the future of online social activity. These applications combine online shopping and social networking, taking the experience to a practical and enjoyable level. Shared shopping technology is intended to raise the general public's level of expectation for online shopping and social networking experiences.

Example Practical Applications

Scenario 1: Shared Shopping on a Single Web Store

A father in Ohio has a daughter who is away at college in California. The daughter needs some supplies, which can be purchased online. The daughter can “take” her father to the stores she wants to visit. They can chat via text, audio, and video while shopping together. Since the father has chosen the proper permissions, the daughter can add things to her father's cart. There is one item on which they want her sister's opinion, so they send the sister an invitation to join in. When they are finished shopping, the father checks out and pays for his daughter's items.

When this shared shopping session was set up, it was pre-established that the daughter would control the shopping experience. While each shopper was set to have his or her own cart, the daughter was also set for the ability to see her father's cart and add items to it.

Scenario 2: Shared Shopping Mall—Multiple Web Stores on a Single Platform

A bride-to-be and her six bridesmaids need to shop online for wedding items. Some of the items they seek will be purchased by the bride only—others will be purchased by each of the bridesmaids, separately. The maid of honor sends out an invitation to the bridal party to “meet” at the online mall at a certain time. As each member of the bridal party clicks the link she received in the email, she joins the online shopping group.

The bride leads the shared shopping group through the mall to view the items she wants them to see. Every page in the store that she visits appears on the screen of the group. Group members may wander a way for a moment to look at something on their own, and then return to the group.

When this shared shopping session was set up, it was pre-established that the bride would control the shopping as a default; that the control could be passed to anyone in the group; that each shopper had her own cart and could not view the contents of anyone else's cart; and that group members could wander away and rejoin the group later.

Scenario 3: Shared Shopping Club—a Way to Socialize and Meet Others

A shopper goes to her favorite online music store to download some new songs. There she sees other people who are interested in the same type of music that interests her. After chatting briefly with one person, she decides to shop with her new friend and listen to music that he wants to play for her. They each have their own private cart, and can individually control what level of chat they want (text, audio, video). Since they have made their shopping group public, other shoppers interested in the same music can follow along and participate in the chat. The first shopper is enjoying the shopping so she decides to send an invitation to her best friend, who also joins in. A representative from the store, recording label, or even the artist could join the group and provide further insight into the musical selection.

The original shopper enjoyed the experience so much that she invited all of the group members to become a permanent shared shopping club. The music club meets regularly and the membership has grown to the point where the store provides a guest speaker to talk about the newest musical selections that would be of interest to them.

Scenario 4: Shared Shopping Service—on a Single Web Store for Customer Service

A shopper visits an online store. The saleswoman at the store sees the shopper comes in, and greets the shopper via a text, audio, or video chat. The saleswoman asks the shopper if she would like help finding anything today. The shopper says she would like to purchase a heater, but doesn't know which model she needs. The saleswoman asks several questions about the space the customer wishes to heat, and then walks through the store with the customer showing her several models. The customer decides that she needs not only one heater, but two as the saleswoman recommended. The saleswoman is able to add the items to the customer's cart, and “walk” her to the checkout where the sale is completed.

Scenario 5: An ad-hoc Multi-Store Comparison Shopping Group is Offered a Discount

A large family group meets at the online mall and forms a shared shopping group. The group decides to shop together at a major electronics dealer to purchase a new television for their matriarch. The merchant sees the group, sees that they have televisions to compare from several other stores in the mall's multi-store shared compare function. The merchant recognizes that they are comparison shopping and steps in to close the deal by offering a substantial discount.

Scenario 6: Friends Meet in Shared Shopping Mall Common Area, Another Friend Joins Group

A group of three college student friends from different cities are wandering through the promenade of the mall, reading the signage, deciding where to go. They spot the arcade and decide to play a game. In the arcade they see another old buddy who then joins the group. The group plays a vintage video game and then wanders back out into the mall promenade. They make a permanent contact with their long lost friend by getting him to join the mall's social network.

Scenario 7: Shopping Together for Gifts at Megastore

A husband and wife go shopping at an online megastore that features shared shopping. The husband asks the wife to find something she likes. As they wander through the store discussing the items, the husband adds several items to his private cart, which is visible only to him. When they have finished shopping, he can decide from the items in his cart which ones he will buy, and can check out without the wife being able to see what he has purchased.

Scenario 8: “Driver” is in the Store Using a Smart Phone to Initiate Shared Shopping via a Scan of a Physical Bar Code or QR Code on Hard Good

A woman is shopping for a gift for her mother. She sees a sweater that she thinks her mother would love. She wants the opinion of two siblings who are not in the store with her. So she invokes the shared shopping application on her smartphone, scans the bar code of the sweater, which initiates a shared shopping session. She invites her siblings, who see the store's online catalog version of the same sweater. After the siblings all agree she would love it, it is placed into the shared cart, which operates as in other shared shopping sessions.

Scenario 9: Two In-Store Shoppers Form an ad-hoc Shopping Group Inside the Brick and Mortar Store

Two in-store shoppers have entered a brick and mortar store, and have smartphones with the location-aware shared shopping feature enabled. They have permitted other people to find them and shop in a group. They are standing near the kayaks, and can physically find one another, already knowing there is interest in discussing the merits of the various models. At the same time, they can bring in a 3^{rd} shopper to their shopping group, perhaps a kayak expert, who can see the same items online when the in-store shopper scans the barcode. The shopping group can discuss the products via real-time communications. Stores could contract with experts to provide superior assistance and options on products. Experts could be paid by shoppers to shop with them and help pick out appropriate products. An expert can join the shopping group as well.

Scenario 10: A Teen Shops in Brick and Mortar Store for Prom Suit—Dad Pays for Items Remotely

A teen boy needs to get some new clothes for a school dance. He has gone to the brick and mortar store and chosen his outfit. Using his smartphone, he scans the bar codes of the items that he wants to buy. His father, who is online at his office in another city, receives an invitation via email to shop with his son. He views the items that his son has chosen and pays for the items that his son has placed in the shared shopping cart. After the father pays for the items, the salesperson wraps up the purchased items for the son to take with him when he leaves the store.

Scenario 11: Bill is Split Among Shared Shopping Group

In this case, an online shared shopping group has purchased a retirement present for a co-worker. When they check out, it is determined that each person will split the invoice evenly. Upon checkout, the shared shopping application bills each of the credit cards the amount that is expected. Once all payments have been made, the item may be shipped or picked up at the store.

Scenario 12: Roommates

Three roommates want to go shopping for college dorm items. They feel that its best to split the costs equally amongst themselves. The items include a TV, a DVD player and a stereo system. They decide that it is best to order these items online and have them delivered to the dorm room. None of the students have credit cards. However they have debit cards. Each of them however, has a limit of $350.00 in the account. Therefore none of them can pick up the whole bill. To further complicate things, they feel that they will not pay each other back in satisfaction. Regardless of the location they can create a shopping group and add these items to the cart and split the bill. They create a shopping group and add the items to the cart and decide to split the bill evenly. With tax and shipping on this order it comes to $999.99. This split 3 ways is $333.33. This is under the limit of each card.

Example: Household items. Note: This example is very practical and realistic because married couples may choose to report income separately and choose to split the cost of living expenses. For example, a husband and wife report income separately. They share some living expenses, such as toiletries and groceries. This couple chooses to track expenses separately. They can use share shopping to do so. Taking this situation farther into the process, this couple needs to buy some items for their house. Paper towels, silverware, glasses, and groceries. They can split the bill 50/50. This would allow them to track their expenses separately. Furthermore, they could purchase these items at their house and pick these items up at an in store location without worrying about who paid for what. In both of these examples this items are purchased for the group. Whether it be roommates or a household. Everyone receives a benefit from the items purchased. Therefore everyone should share in the cost of the item.

Scenario 13: Housemates Paying the Utility Bill Online Using the Split Checkout Function:

Four housemates have a utility bill worth $360. They have to pay this utility bill in full otherwise the utility will be shut off. The bill itself is due on the day they decide to pay it. The utility company could benefit from using shared shopping. This would allow the group of housemates to form a group and pay the bill. Further, these roommates want to split the bill evenly. $360 four ways is $90 per person (or unevenly if desired). Each person puts the amount personally owed for payment, and the negotiation process begins. After successful confirmation the housemates avoid the potential utility shutoff. The negotiation process provides security that each person paid their respective amount, otherwise the transaction would not be completed. Finally, this example can go further. Suppose one member of the house has $0 in his bank account to pay for the bill. This person could have a member of the family join the shopping group and pay for their respective portion.

Scenario 14: Approving a Purchase Made my One Person:

Here, a man and a women form a shopping group to browse items. The man tells the women there is no specific purpose for the activity. Yet he alerts the customer service representative that he is looking for an engagement ring. The customer service representative can ask the women various questions about her tastes in jewelry. For example, the cut of the diamond or her preference on gold or sterling silver, and her ring size. This information can be relayed from the customer service representative to the man. Furthermore the customer service representative could send links to specific products to the man. The man can pay for them without the women knowing. There are many products, specifically high end products, that may require customization or a decision by the end consumer regarding preferences. This information can be provided by the customer service representatives while another person could pick up the bill.

Scenario 15: Customer Service Knowledge:

The ability to chat with a customer service representative can ensure better decisions made by the consumer. For example, shopping for a computer is one such situation. Computers come in various shapes, sizes and specifications. With these options come various prices. So how do consumers know which option is best for them? This is where the ability to “talk” to someone matters. A customer service representative can ask questions related to the purpose of use: Is it for gaming? Is it for accounting? Is it for business? An end consumer may not be well aware of such options or the details regarding buying computers. A representative can help these consumers through the purchase, thus ensuring a satisfied consumer and a profitable transaction.

Many other example embodiments of the invention can be provided through various combinations of the above described features. Although the invention has been described hereinabove using specific examples and embodiments, it will be understood by those skilled in the art that various alternatives may be used and equivalents may be substituted for elements and/or steps described herein, without necessarily deviating from the intended scope of the invention. Modifications may be necessary to adapt the invention to a particular situation or to particular needs without departing from the intended scope of the invention. It is intended that the invention not be limited to the particular implementations and embodiments described herein, but that the claims be given their broadest reasonable interpretation to cover all novel and non-obvious embodiments, literal or equivalent, disclosed or not, covered thereby.

What is claimed is:

1. A method of providing an online shared shopping session, comprising the steps of:
providing an online store for access to an initial shopper using a communication device;
providing the initial shopper with a communication interface for inviting one or more additional shoppers to shop at the online store together as a group of shoppers;
sending a message to the additional shoppers invited by the initial shopper over a communication network, such that each one of said additional shoppers can join the group of shoppers by responding to said message, wherein said additional shoppers each participate in shopping at the online store using a communication device distinct from others of said shoppers;
providing each one of said shoppers of the group of shoppers with a link to a shared shopping cart for adding one or more items to said shared shopping cart, such that contents of the shared shopping cart can be viewed by all of said shoppers; and
providing each one of said shoppers with a payment interface, such that more than one of said shoppers contributes payment toward purchase of the items added to said shared shopping cart.

2. The method of claim 1, further providing a chat function so that the shoppers in the group can chat with each other while shopping.

3. The method of claim 2, wherein said chat function utilizes the communication device of each shopper.

4. The method of claim 1, further providing the step of providing each one of said shoppers with a personal shopping cart for purchasing items outside of the group.

5. The method of claim 1, further comprising the step of allocating a payment percentage to each one of said shoppers, wherein each one of said shoppers contributes payment toward the purchase of the items according to said payment percentage.

6. The method of claim 1, further providing a second online store, wherein said shoppers can also add items from said second online store to said shared shopping cart.

7. The method of claim 6, wherein, in support of said shared shopping session, said online store is hosted on a first server system operated by a first client and wherein said second online store is hosted on a second server system separate from said first server system and operated by a second client.

8. The method of claim 7, wherein a central server system separate from said first server system and said second server system supports said shared shopping session.

9. A method of providing an online shared shopping session, comprising the steps of:
registering a plurality of individual shoppers to a shopping group, wherein at least two of said shoppers access said shared shopping session using different communication devices;
providing each one of said shoppers with access to a shared shopping cart for indicating items for purchase by the shopping group, wherein each one of said shoppers can add items for purchase to said shared shopping cart using one of said communications devices;
for each one of said shoppers, accepting an individual payment percentage amount indicating a percentage of the total cost of said items to be paid by a corresponding one of said shoppers; and
providing a checkout function to be activated by one or more of said shoppers, wherein when said checkout function is completed, each one of said shoppers has contributed payment toward purchase of said items according to the individual percentage amount corresponding to that one of said shoppers.

10. The method of claim 9, further providing a chat function so that the shoppers in the group can chat with each other while shopping.

11. The method of claim 10, wherein said chat function utilizes the communication device of each shopper.

12. The method of claim 9, further providing the step of providing each one of said shoppers with a personal shopping cart for purchasing items outside of the group.

13. The method of claim 9, further providing a second online store, wherein said shoppers can also add items from said second online store to said shared shopping cart.

14. The method of claim 13, wherein, in support of said shared shopping session, said online store is hosted on a first server system operated by a first client and wherein said second online store is hosted on a second server system separate from said first server system and operated by a second client.

15. The method of claim 14, wherein a central server system separate from said first server system and said second server system supports said shared shopping session.

16. A method of providing an online shared shopping session, comprising the steps of:
registering a plurality of individual shoppers to a shopping group, wherein at least two of said shoppers are accessing said shared shopping session using different communication devices;
providing each one of said shoppers with access to a shared shopping cart for indicating items for purchase by the shopping group, wherein each one of said shoppers can add items for purchase to said shared shopping cart;
for each one of said shoppers, accepting an individual payment percentage amount indicating a percentage of the total cost of said items to be paid by a corresponding one of said shoppers;
validating that the sum of said individual payment percentage amounts of all of said shoppers totals one-hundred percent; and
providing a checkout function to be accessed by each one of said shoppers, wherein for all of said shoppers: each one of said shoppers executes an individual checkout process for receiving payment information from that one of said shoppers, such that subsequent to said individual checkout process, that one of said shoppers has completed the checkout process and has contributed payment toward purchase of said items according to the individual percentage amount corresponding to that one of said shoppers, wherein
when any one of said shoppers first accesses the checkout function, the shared shopping cart is locked such that no more items can be added to the shared shopping cart by any of said shoppers; and
when said individual checkout function is completed for all of said shoppers, the sale of said items to said group is completed.

17. A method of providing an online shared shopping session, comprising the steps of:
providing an online shopping mall including a first shopping site and a second shopping site;
registering a plurality of individual shoppers to a shopping group, wherein at least two of said shoppers are accessing said shared shopping session using different communication devices;
providing each one of said shoppers with access to a shared shopping cart for indicating items for purchase by the shopping group from either of said first shopping site and said second shopping site, wherein each one of said shoppers can add items for purchase to said shared shopping cart;
for each one of said shoppers, accepting an individual payment percentage amount indicating a percentage of the total cost of said items to be paid by a corresponding one of said shoppers;
validating that the sum of said individual payment percentage amounts of all of said shoppers totals one-hundred percent;
providing a checkout function to be accessed by each one of said shoppers, wherein for all of said shoppers: each one of said shoppers executes an individual checkout process for receiving payment information from that one of said shoppers, such that subsequent to said individual checkout process, that one of said shoppers has completed the checkout process and has contributed payment toward purchase of said items according to the individual percentage amount corresponding to that one of said shoppers, wherein
when any one of said shoppers first accesses the checkout function, the shared shopping cart is locked such that no more items can be added to the shared shopping cart by any of said shoppers;
when said individual checkout function is completed for all of said shoppers, the sale of said items to said group is completed; and
providing payment to said first shopping site and said second shopping site based on items purchased by the group provided by the respective site.

18. A method of providing an online shared shopping session, comprising the steps of:
providing an online store for access to an initial shopper using a communication device;
providing the initial shopper with a communication interface for inviting one or more additional shoppers to shop at the online store together as a group of shoppers;
sending a message to the additional shoppers invited by the initial shopper over a communication network, such that each one of said additional shoppers can join the group of shoppers by responding to said message, wherein said additional shoppers each participate in shopping at the online store using a communication device distinct from others of said shoppers;
providing each one of said shoppers with access to a shared shopping cart for indicating items for purchase by the shopping group, wherein each one of said shoppers can add items for purchase to said shared shopping cart, wherein the contents of the shared shopping cart can be viewed by all of said shoppers;
providing each one of said shoppers with a personal shopping cart for purchasing items outside of the group;
providing a chat function so that the shoppers in the group can chat with each other while shopping;
for each one of said shoppers, accepting an individual payment percentage amount indicating a percentage of the total cost of said items to be paid by a corresponding one of said shoppers;
validating that the sum of said individual payment percentage amounts of all of said shoppers totals one-hundred percent;
providing a checkout function to be accessed by each one of said shoppers, wherein for all of said shoppers: each one of said shoppers executes an individual checkout process for receiving payment information from that one of said shoppers, such that subsequent to said individual checkout process, that one of said shoppers has completed the checkout process and has contributed payment toward purchase of said items according to the individual percentage amount corresponding to that one of said shoppers, wherein
when any one of said shoppers first accesses the checkout function, the shared shopping cart is locked such that no more items can be added to the shared shopping cart by any of said shoppers; and
when said individual checkout function is completed for all of said shoppers, the sale of said items to said group is completed.

19. A method of providing an online shared session, comprising the steps of:
providing an initial user with a communication interface for inviting one or more additional users to access said session as a group of users;
sending a message to the additional users invited by the initial user over a communication network, such that each one of said additional user can join the group by responding to said message, wherein said additional user each participate in the shared session using a communication device distinct from others of said users;
displaying one or more common pages among all of said users during said online shared session, wherein said sharing includes sending URL information of a page viewed by one of said users to the others of said users for use in displaying the page on their respective communication devices; and
providing a chat function so that the users in the group can chat with each other during said shared session.

20. A method of providing an online shared shopping session, comprising the steps of:
providing a central server owned by a first vendor to support the online shared shopping session;
providing a remote server for supporting a merchant shopping site originally independent of the shared shopping session;
providing a software plug-in for installation and execution in the remote server to enable the merchant shopping site to support the shared shopping session, wherein providing the shared shopping session includes the steps of:
providing an online store for access to an initial shopper using a communication device,
providing the initial shopper with a communication interface for inviting one or more additional shoppers to shop at the online store together as a group of shoppers,
providing each one of said shoppers of the group of shoppers with a link to a shared shopping cart for adding one or more items to said shared shopping cart, such that contents of the shared shopping cart can be viewed by all of said shoppers, and
providing each one of said shoppers with a payment interface, such that more than one of said shoppers contributes payment toward purchase of the items added to said shared shopping cart; and
providing payment from the merchant to the vendor for supporting said shared shopping session.
